(19) United States
(12) Patent Application Publication
(10) Pub. No.: US 2025/0209754 A1
(43) Pub. Date: Jun. 26, 2025

(54) TECHNIQUES FOR ORIENTING A VISUAL REPRESENTATION OF A REMOTE USER BASED ON PHYSICAL LANDMARKS WITHIN LOCAL PHYSICAL SURROUNDINGS OF A USER DURING A SHARED ARTIFICIAL-REALITY INTERACTION

(71) Applicant: Meta Platforms Technologies, LLC, Menlo Park, CA (US)

(72) Inventors: Diogo Cunha, Zürich (CH); Gioacchino Noris, Zurich (CH); Henrik Hegner Tomra Skovsgaard, Menlo Park, CA (US); Britta Hummel, Zürich (CH); Vasyl Baran, London (GB)

(21) Appl. No.: 18/980,947

(22) Filed: Dec. 13, 2024

Related U.S. Application Data
(60) Provisional application No. 63/612,996, filed on Dec. 20, 2023.

(51) Int. Cl. G06T 19/00; G06T 7/73; G06V 20/20

(52) U.S. Cl. CPC G06T 19/006; G06T 7/73; G06V 20/20

(57) ABSTRACT

A method of performing a shared artificial-reality interaction using an artificial-reality headset is provided. The method includes obtaining local data about a local physical area in which a user is wearing an artificial-reality headset. The method further includes identifying, via the local data, a local orientation of the user relative to the local physical area. The method further includes obtaining remote data indicating a remote orientation of a remote user relative to a remote physical landmark within a remote physical area different than the local physical area. And the method further includes, based on the local data, the local orientation of the user, and the remote data, and presenting, at the artificial-reality headset, a visual representation of the remote user at a co-present position within the local physical area with a representative orientation relative to (i) the local physical landmark and (ii) the local orientation of the user.

### RELATED APPLICATIONS

This applications claims priority to U.S. Prov. App. No. 63/612,996, filed on Dec. 20, 2023, and entitled “Techniques for Orienting a Visual Representation of a Remote User based on Physical Landmarks within Local Physical Surroundings of a User During a Shared Artificial-Reality Interaction,” which is incorporated herein by reference.

### TECHNICAL FIELD

This disclosure relates generally to artificial-reality (AR) headsets, including but not limited to techniques for orienting a visual representation of one or more remote users (e.g., a three-dimensional avatar representation) within a local physical area that a user is using during a shared AR interaction with the one or more remote users that are not in the local physical area.

### BACKGROUND

Interactions between users of different electronic devices via telepresence (e.g., video calling) is gaining popularity. A fundamental problem with telepresence is the dissociation between the users engaged in the experience based on, for example, the presentation of a volume of three-dimensional space that the other user is in (e.g., a remote physical area) being presented on a two-dimensional screen within a different three-dimensional space that the local user 302 is in while they are engaged in the telepresence interaction. Augmented-reality devices allow for three-dimensional visualizations of content (e.g., spatial computing content), but still have drawbacks related to telepresence. For example, each of the users interacting via a shared AR experience may be located in remote physical areas from one another, and each of the remote physical areas may have unique space layouts. Further, each of the users may be interacting with similar objects within each of the space layouts differently.

As such, there is a need to address one or more of the above-identified challenges. A brief summary of solutions to the issues noted above are described below.

### SUMMARY

Thus, improvements are needed for facilitating interactions between physically remote users of AR systems to properly position representations of the respective users within the other users' remote physical areas to facilitate co-present interactions via AR headsets of the physically remote users. The disclosed embodiments use identifications of physical landmarks (e.g., chairs, desks, televisions, computer monitors, one or more locations corresponding to semantic properties of a physical object (e.g., spots where seats would be likely to be placed at a table), etc.) to identify co-present positions to place users within different physical areas based on the respective physical landmarks in the physical areas. For example, if one user is sitting at a desk, facing a wall, and another user is sitting at a table in the center of a room, it would be more likely for the users to be conversing while sitting across from each other at the table, than it would be to place one user at a location in the wall next to the desk.

A method of performing a shared AR interaction using an AR headset is provided. The method further includes obtaining local data about a local physical area in which a user is wearing an AR headset. The method includes identifying, via the local data, a local orientation of the user relative to the local physical area. The method further includes obtaining remote data indicating a remote orientation of a remote user relative to a remote physical landmark within a remote physical area different than the local physical area. And the method further includes, based on the local data, the local orientation of the user, and the remote data, identifying a local physical landmark that satisfies similarity criteria with respect to the remote physical landmark, and presenting, at the AR headset, a visual representation of the remote user at a co-present position within the local physical area with a representative orientation relative to (i) the local physical landmark, and (ii) the local orientation of the user.

The features and advantages described in this specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings, in which like reference numerals refer to corresponding parts throughout the figures.

FIGS. 1A to 1D illustrate an example of physical-landmark based positioning techniques being used to facilitate a shared AR interaction, in accordance with some embodiments.

FIG. 2 shows an example method flow chart for performing a shared AR interaction using an AR headset, in accordance with some embodiments.

FIGS. 3A, 3B, 3C-1, and 3C-2 illustrate example AR systems, in accordance with some embodiments.

FIGS. 4A and 4B illustrate an example wrist-wearable device, in accordance with some embodiments.

FIGS. 5A, 5B-1, 5B-2, and 5C illustrate example head-wearable devices, in accordance with some embodiments.

FIGS. 6A and 6B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types (e.g., embodiments and/or implementations) of AR systems. Artificial reality, as described herein, is any superimposed functionality and or sensory-detectable presentation provided by an AR system within a user's physical surroundings. Such artificial-realities can include and/or represent virtual reality (VR), augmented reality, mixed AR (MAR), or some combination and/or variation one of these. An AR environment, as described herein, can be used to describe one of or a combination of any of the following: VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid reality, and other types of mixed-reality environments.

AR content can include completely generated content or generated content combined with captured (e.g., real-world) content. The AR content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create AR content in an artificial reality and/or are otherwise used in (e.g., to perform activities in) an AR environment.

As described herein, an augmented-reality headset is an AR headset that is configured to present a representation of at least a portion of a user's physical surroundings (e.g., via passthrough imaging data) in conjunction with AR content. In accordance with some embodiments, at least one real-world object in a user's physical surroundings may be presented as an AR-interactable visual representation of the physical real-world object (e.g., a digital twin), such that the representation can be modified and/or otherwise interacted with using the AR content.

As described herein, semantic properties of physical objects (e.g., within users' physical surroundings) are those properties that define the meaning of the physical objects. Semantic properties can be intrinsic to the object, such as its shape, size, color, and/or material, or they can be relational, such as function, purpose, or location.

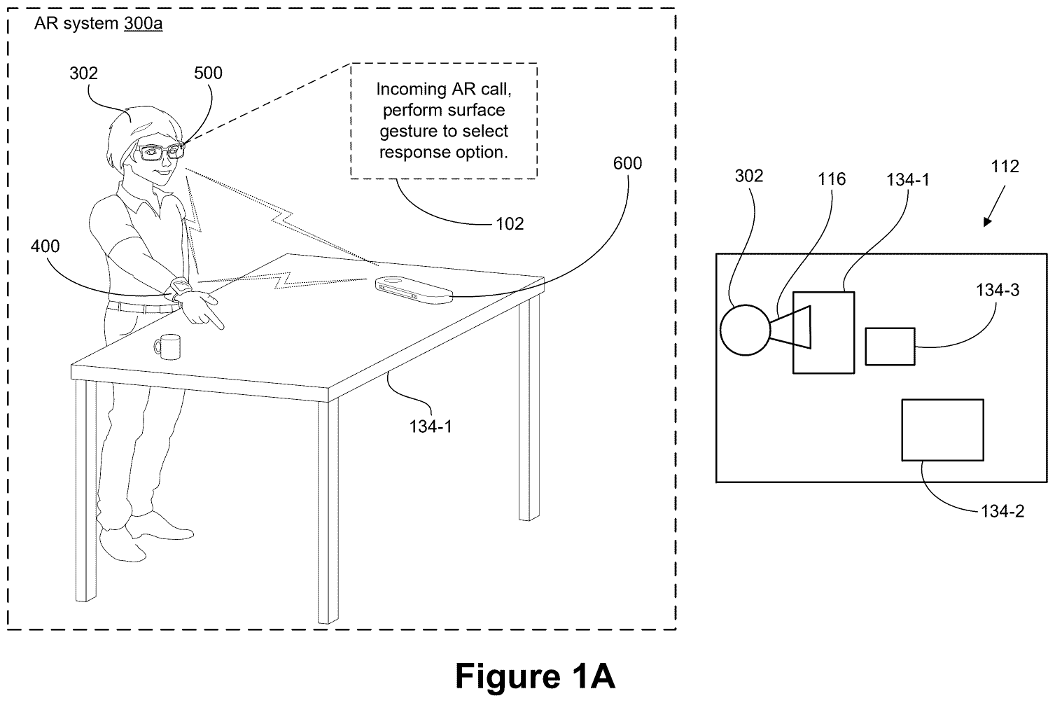

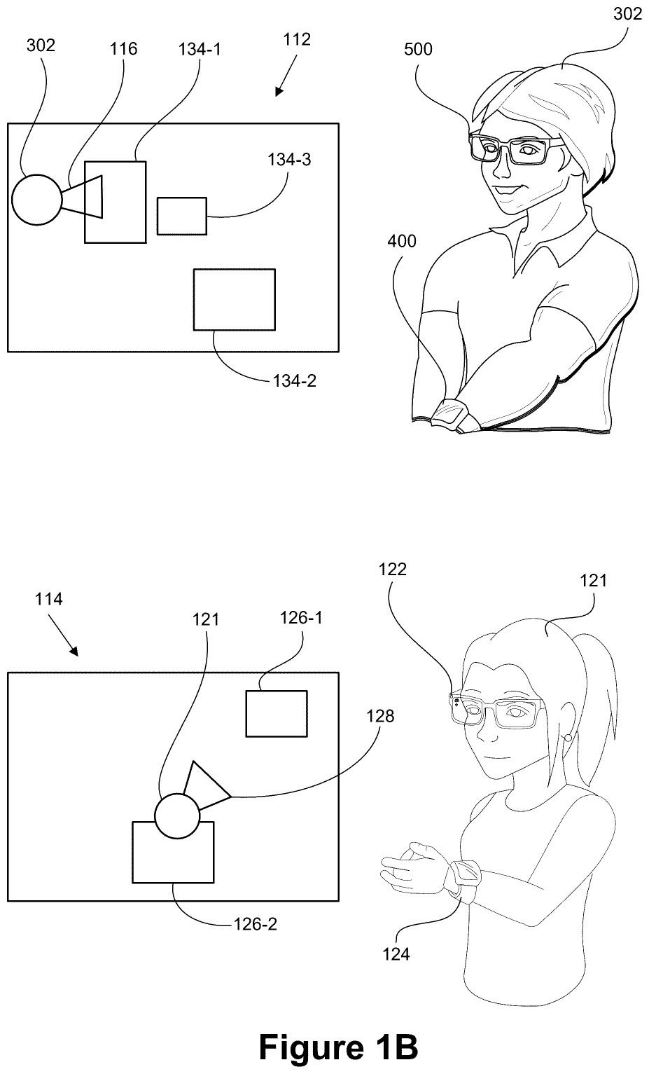

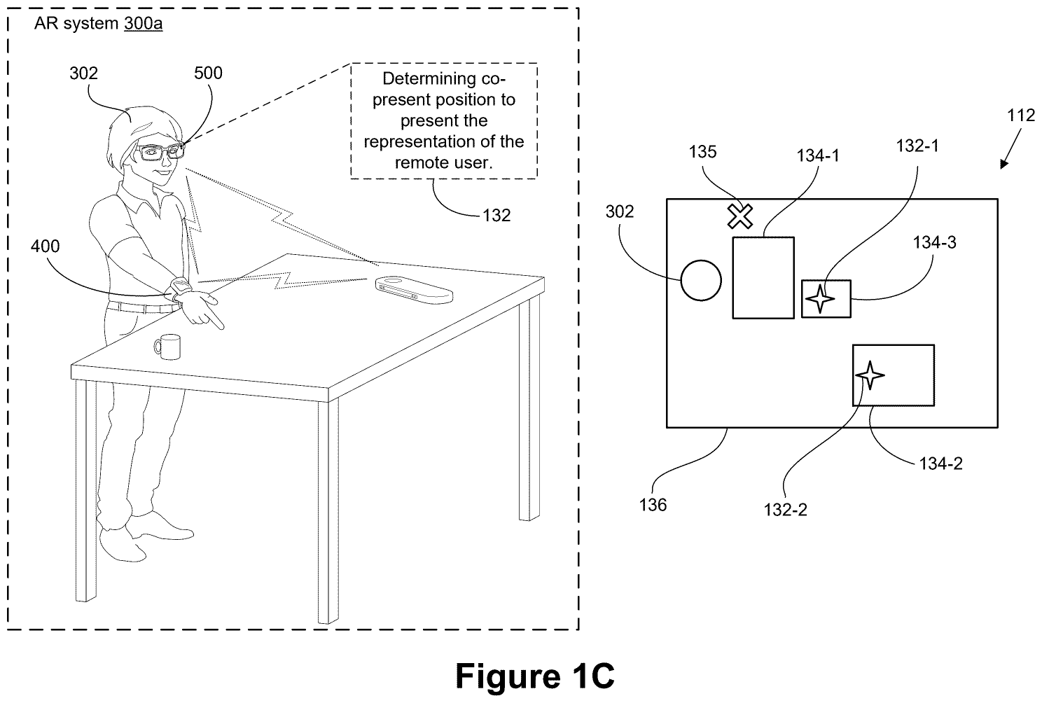

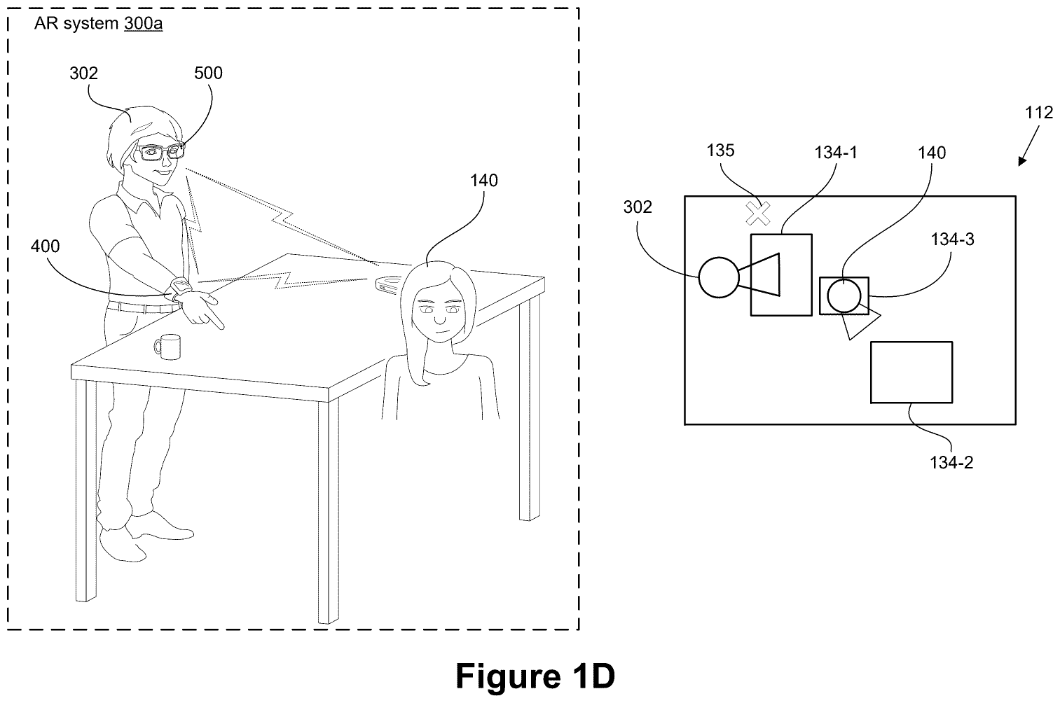

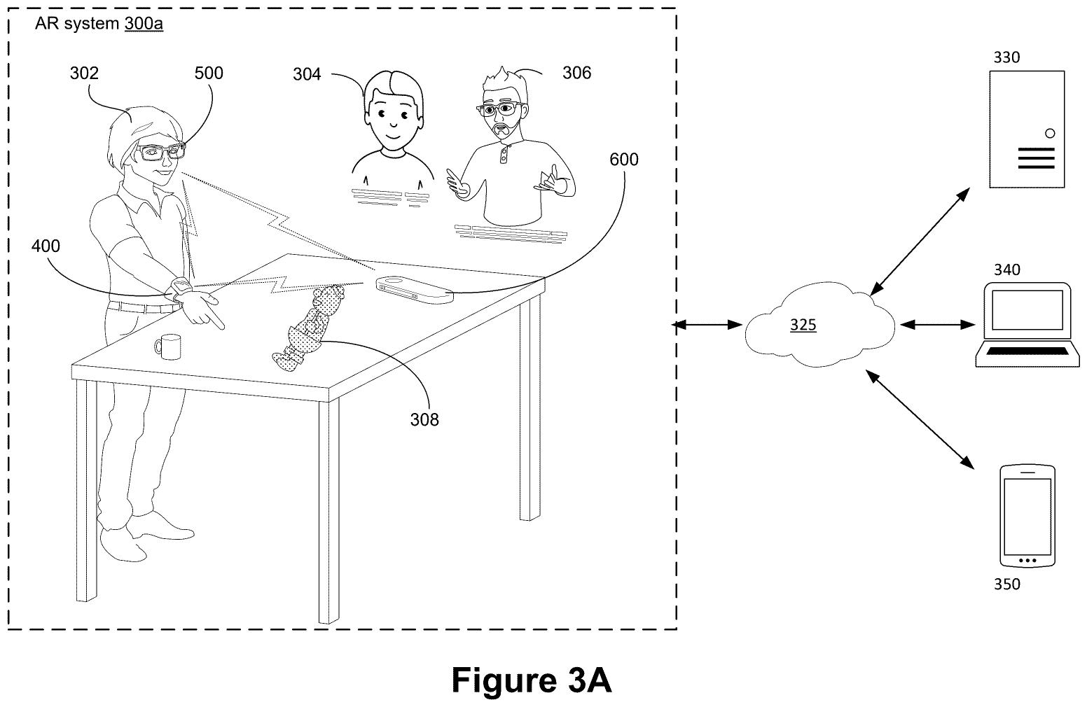

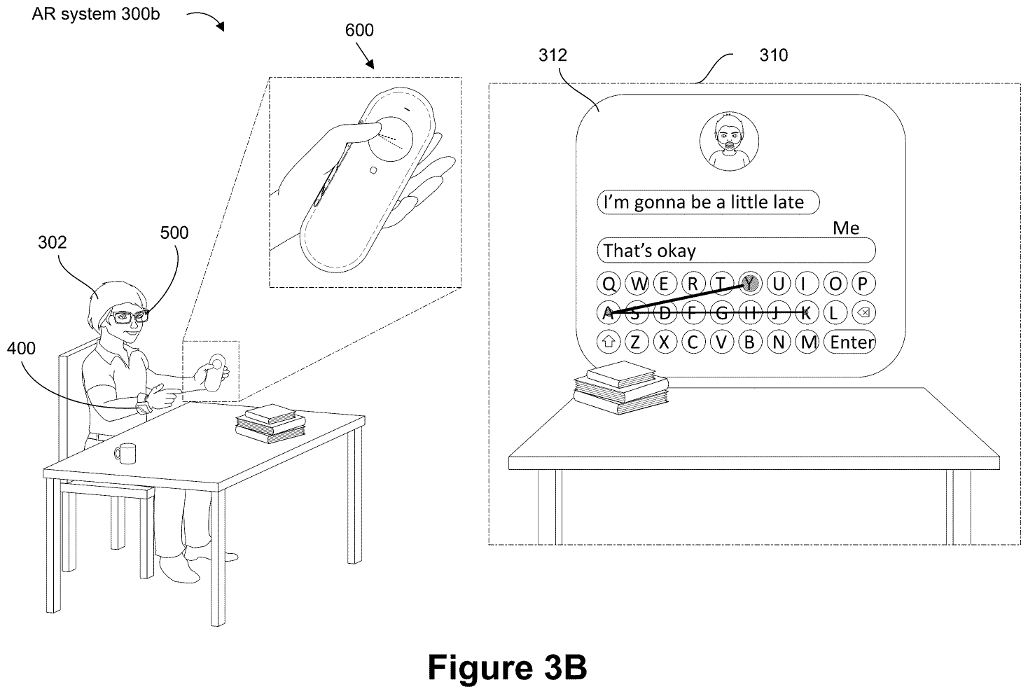

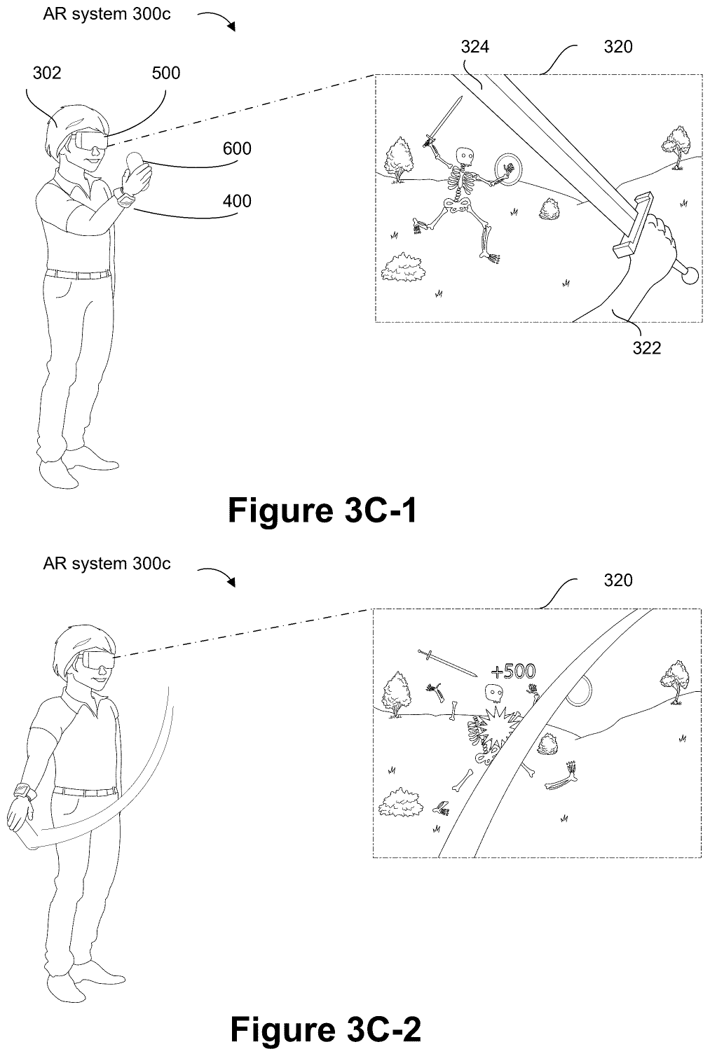

FIGS. 1A to 1D illustrate an example of physical-landmark based positioning techniques, which are used to facilitate a shared AR interaction (e.g., an AR interaction including a plurality of different users of different electronic devices), in accordance with some embodiments. For case of explanation, the sequence illustrated by FIGS. 1A to 1D will be described with respect to example systems and devices that are discussed in more detail with respect to FIGS. 3A to 6B below. Although the example systems and devices described with respect to FIGS. 3A to 6B include specifically-referenced components and types of components, one of skill in the art will understand that the interactions described with respect to FIGS. 1A to 1D can be performed with additional and/or alternative electronic devices not specifically discussed herein but comprising components for enabling the capabilities of the components discussed herein.

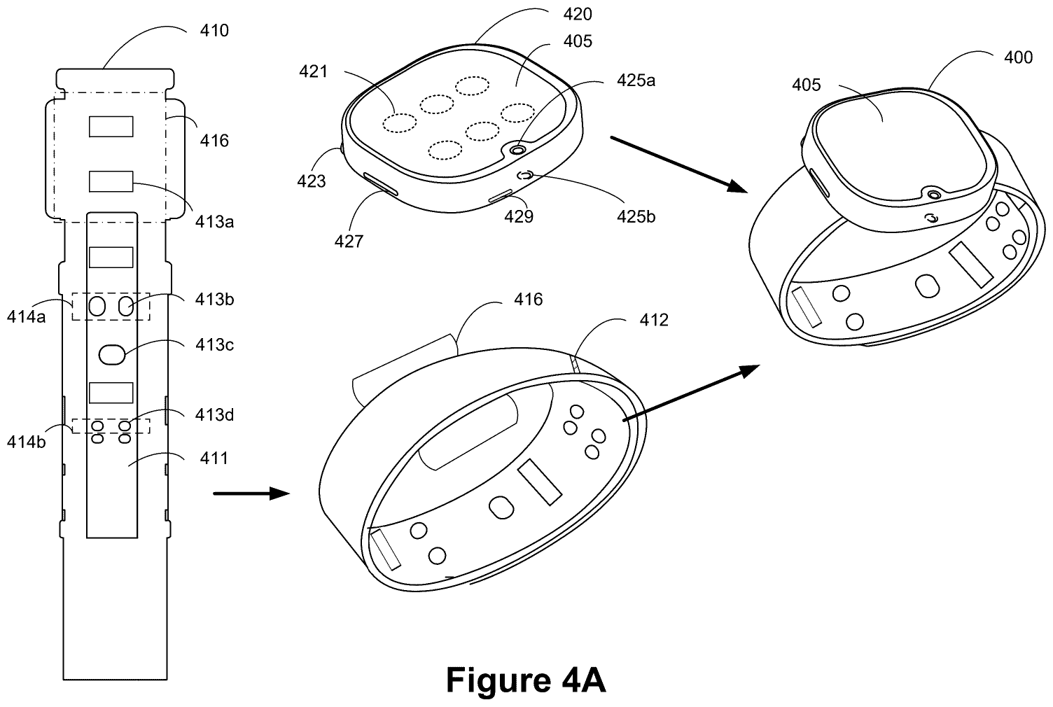

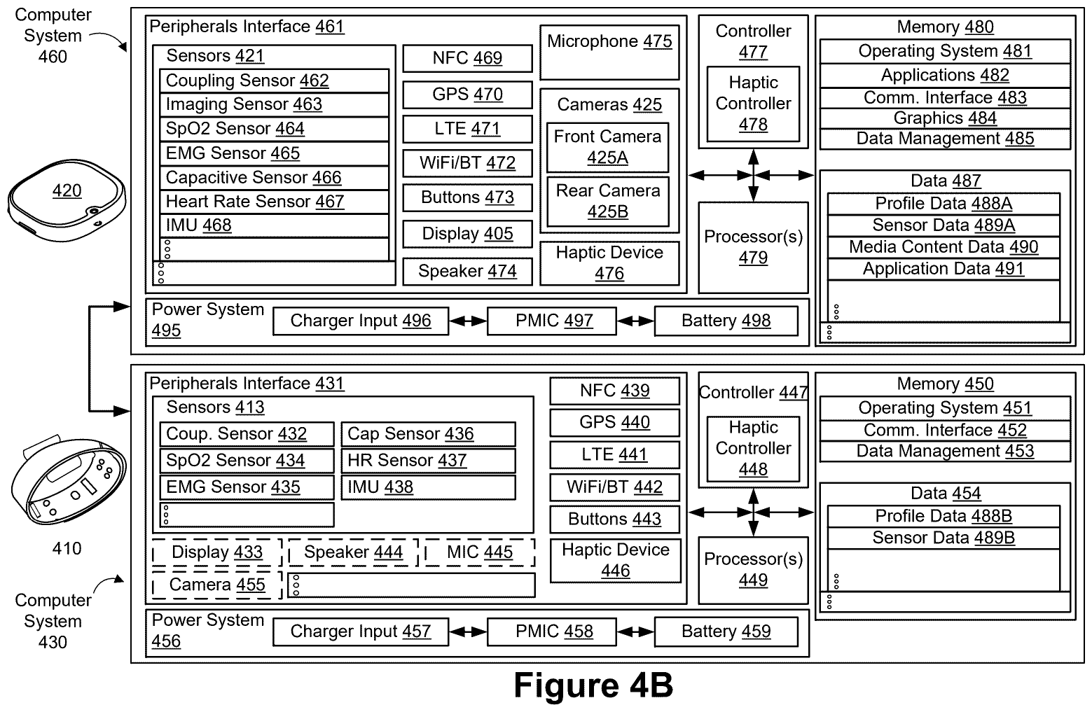

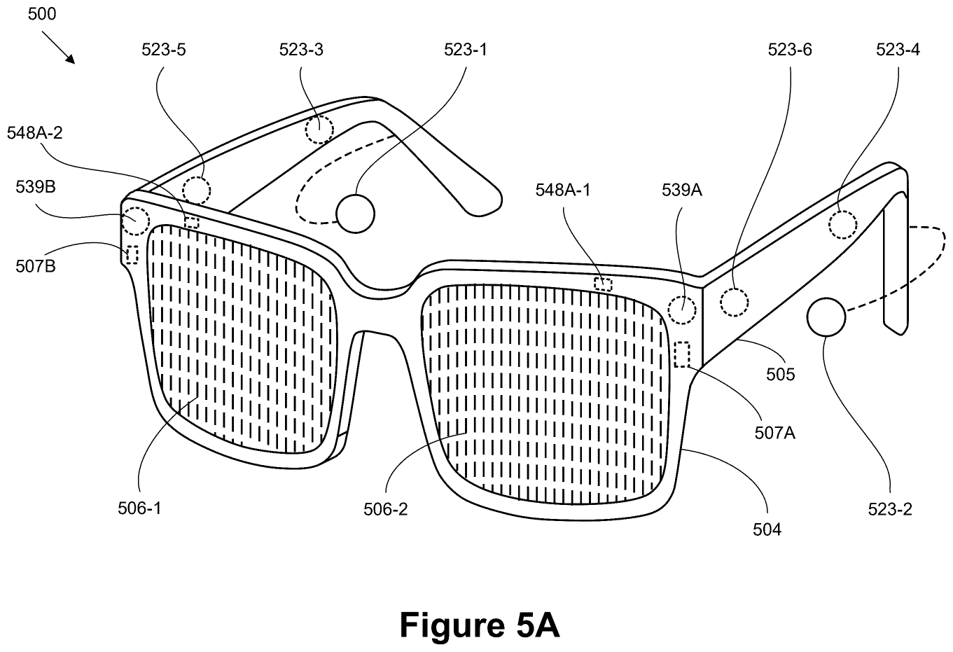

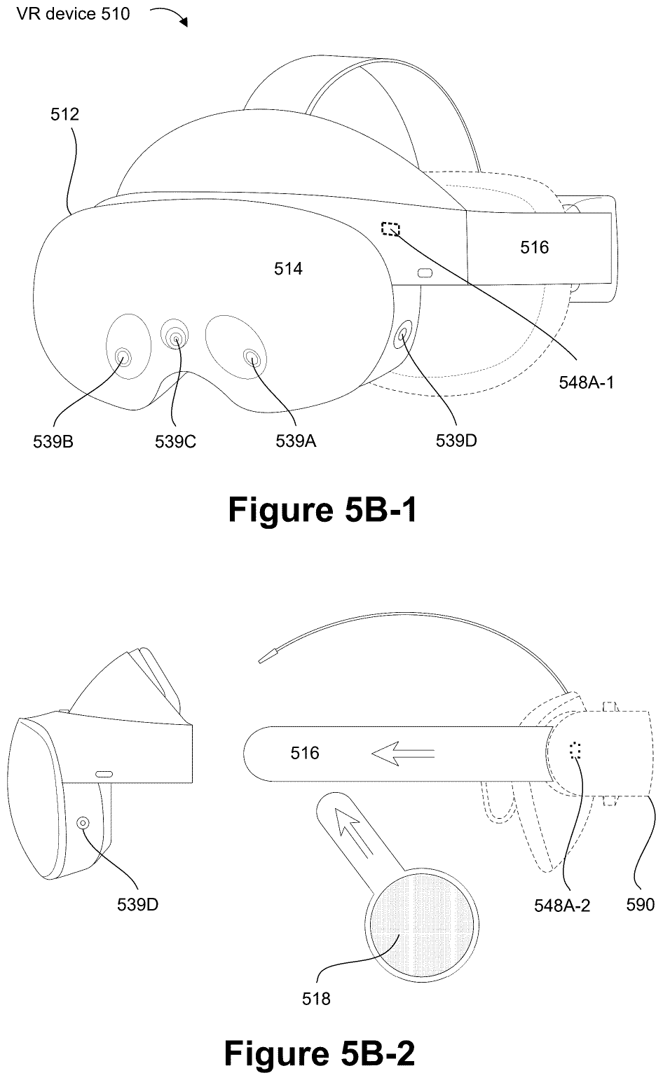

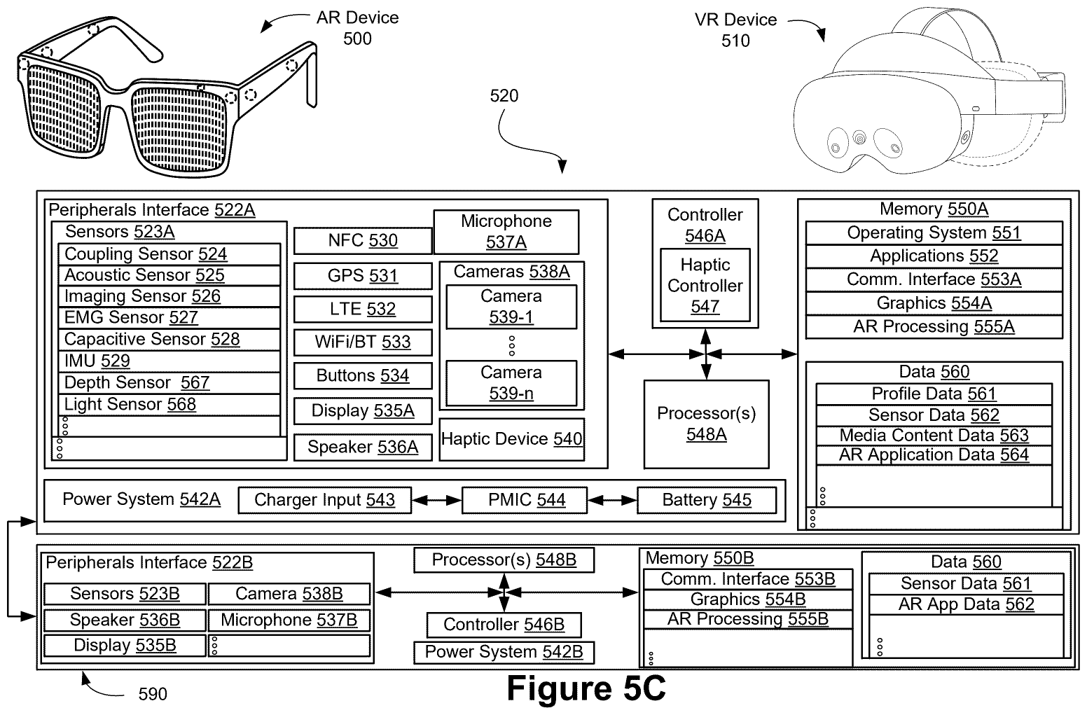

FIG. 1A shows a user 302 within a local physical area 112 while the user 302 is wearing an AR device 500, including some or all of the components described with respect to the AR device 500 in FIGS. 5A to 5C. In accordance with some embodiments, the operations discussed with respect to FIGS. 1A to 1D occur when the user 302 is using a passthrough display mode of the AR device 500, such that at least a portion of the physical area 112 is being viewed by the user 302 (e.g., unobstructed by any virtual objects (e.g., user interfaces) within the portion of the physical area 112). The user 302 is also wearing a wrist-wearable device 402, which may include, among other components described in more detail with respect to FIGS. 4A and 4B, one or more sensors for detecting actions and/or interactions of the user 302, including gestures performed by the user 302 to interact with visual AR content being presented by the AR device 500. The physical area 112 includes a handheld intermediary processing device (HIPD) 600, which may be configured to be used to process data from one or more processors of the AR system 300a, including sensors disposed on the HIPD 600.

In FIG. 1A, the AR device 500 is causing a visual representation 102 to be presented in response to receiving an indication that another user 121 has sent the user 302 an electronic message (e.g., an interactive tele-present interaction facilitated by respective AR devices being worn by the user 302 and the other user 121). The visual representation 102 corresponding to the electronic message includes text, stating “Incoming AR call, perform surface gesture to select response option.” In other words, the visual representation 102 includes a notification regarding the electronic message from the other user 121, and indicates to the user 302 that they have different response options for accepting the AR call. For example, in some embodiments, the user 302 can determine whether to (i) accept the AR call as part of the shared AR experience depicted by the remaining portions of the sequence illustrated by FIGS. 1A to 1D, (ii) accept the AR call as an audio-only communication with the user 121, or (iii) reject the call while optionally providing an indication to the user 121 that the user 302 is busy (e.g., immersed in an AR gaming experience). In some embodiments, the AR call may be automatically accepted or rejected by the AR system 300a based on a configuration of the AR system 300a and/or a preference of the user 302. For example, in some embodiments, the AR system 300a is configured to present either an augmented-reality environment, that includes AR content in conjunction with a substantial portion of the physical area 112 that is within the field of view of the user 302, and the AR system 300a is also configured to present a substantially immersive virtual-reality environment to the user that encompasses substantially all of the user's field of view. And the AR system 300a may determine how to process the incoming AR call based on the type of AR environment and/or AR content that is being presented to the user 302 at the time that the call is received (e.g., accepting as an AR call if the user is engaged with an augmented-reality environment, and rejecting the call or causing it to be answered as an audio call if the user is engaged with a virtual-reality environment).

FIG. 1B shows the user 302 in the physical area 112, and the other user 121 in the remote physical area 114. The physical area 112 includes a plurality of real-world objects which are detected by one or more sensors of the AR system 300a. For example, the physical area 112 includes a first physical object 134-1 (e.g., a table), a second physical object 134-2 (e.g., a computer monitor), and a third physical object 134-3 (e.g., a chair). In some embodiments, the objects 134-1 to 134-3 are detected within the physical area 112 based on being within a threshold distance of the user 302 (e.g., an interactable distance, which may be configured for the AR system 300a, and/or the particular AR interaction being performed). In some embodiments, the AR system 300a presents a visual indication of one or more respective boundaries related to the interactive AR interactions, which may be based on the interactable distance, and/or the boundaries of the interactable area may be adjusted by the user 302 and/or actions performed by the user 302 and/or the other user 121 (e.g., changing a gaze direction).

In accordance with some embodiments, imaging sensors 539A and 539B on a front-facing outer surface of the AR device 500 may be configured to capture imaging data in accordance with receiving the indication about the electronic message received from the other user 121 (as indicated by the visual representation 102 shown in FIG. 1A). In addition to detecting the real-world objects 134-1, 134-2, and 134-3 within the physical area 112, the AR system 300a may be configured to determine an orientation of the user 302 within the physical area 112. For example, the map view shown in FIG. 1A includes an indication that the user 302 has a first orientation 116 (including a direction of focus (e.g., a gaze direction)), where the first orientation 116 corresponds to the user 302 facing towards the real-world object 134-1 (the table that the user 302 is standing next to, as illustrated by FIG. 1A). In accordance with some embodiments, data is obtained by the AR system 300a about some portion (e.g., less than all), of the physical area 112, based on detecting the first orientation 116 (e.g., including the first gaze direction) of the user 302 with respect to one or more real-world world objects (e.g., the real-world object 134-1) within the physical area 112.

FIG. 1B also shows a remote physical area 114 where the other user 121 is located, including physical objects, different than the physical objects 134-1 to 134-3, that are located within the physical area 114 of the other user 121 (e.g., a physical object 126-1, and a physical object 126-2), as illustrated by the map view of the remote physical area 114. In accordance with some embodiments, the AR system 300a is configured to collect information about an orientation of the other user 121, similarly to the imaging sensors 539A and 539B of the AR device 500. In some embodiments, one or more of the users are using a handheld intermediary processing device (HIPD) (e.g., the HIPD 600 shown in FIG. 1A), where the respective HIPD is configured to detect aspects of the respective user (e.g., the orientation of the other user 121). In some embodiments, the AR system 300a may obtain data about the remote physical area 114 in order to determine how to present a representation of the other user 121 within the physical area 112 that the user 302 is in while optimizing co-presence of the interaction between the user 302 and the other user 121. As described herein, co-presence refers to the concept of the users experiencing an interaction in a way that represents the semantics of the users' individual interactions in their own physical areas as well as the other physical area in which their respective representations are presented.

FIG. 1C shows the user 302 while the AR system 300a is initiating the interactive video call with the other user 121, after the AR system 300a has obtained data about the physical area 112 (e.g., from sensors of one or more devices of AR system 300a). In some embodiments, as illustrated by the map view of the physical area 112, the AR system 300a is configured to identify and/or itemize physical landmarks and/or other physical objects within a user's respective local physical area. For example, the AR system 300a identifies that there is a physical landmark 132-1 corresponding to a potential location for instantiating the visual representation of the other user 121.

In accordance with some embodiments, the first physical landmark 132-1 is identified based on one or more co-present presentation criteria for facilitating interactions with the user 302. For example, one co-present presentation criteria may be based on semantic properties of the first physical landmark 132-1 (e.g., how it is being used by the user 302). And the AR system 300a identifies another physical landmark 132-2, which may be identified based on the real-world object 134-2 satisfying similarity criteria with respect to a chair that the other user 121 is sitting in within the remote physical area. In some embodiments, one or more physical landmarks are identified based on both the first orientation 116 of the user 302, and the second orientation 128 of the other user 121. For example, the other user 121 may be watching a television in the remote physical area 114, and a respective physical landmark may be identified within the local physical area 112 based on the respective physical landmark's proximity to a different television or other screen-like object within the local physical area 112 that satisfies similarity criteria with respect to the television that the other user 121 is interacting with in the remote physical area 114.

In accordance with some embodiments, after the AR system 300a identifies one or more physical landmarks within the user's physical area (e.g., the physical area 112), the AR system 300a may determine (e.g., identify, select) a respective physical landmark of the one or more physical landmarks to cause the visual representation of the other user 121 to be presented within the physical area 112 of the user 302. The AR device 500 is presenting a visual representation 140 to the user 302, notifying the user 302 that the AR system 300a is determining a location for presenting the visual representation of the other user 121 (stating, “Determining co-present position to present the representation of the remote user.”). In accordance with some embodiments, the AR system 300a may present each of the respective physical landmarks to the user 302, and the user 302 may choose to remove particular physical landmarks from the set of physical landmarks (e.g., the set of physical landmarks 132). In some embodiments, physical landmarks are removed from the set of physical landmarks based, at least in part, on their respective proximities to the user 302. For example, the physical landmark 132-2 may be removed from the set of physical landmarks based on determining that all or a portion of the physical object 134-2 is beyond an interactable distance of the user 302. FIG. 1C also shows an interfering physical landmark 135 being displayed on the overhead map view of the physical area that the user 302 is in. The interfering physical landmark 135 indicates a position where the visual representation cannot be presented, for example, based on a physical object that would interfere with the visual representation of the user 121 (e.g., a wall, and/or a portion of a table that is within a threshold distance of the wall. In some embodiments, determining whether a particular location and/or physical landmark comprises an interfering object is based on the respective orientation that the representation of the respective user would be presented with at the subject location within the physical area.

FIG. 1D shows the user 302 interacting with a visual representation 140 of the other user 121 after the visual representation 140 via the AR system 300a. In FIG. 1D, the other user 121 is being presented (e.g., via the AR system 300a) to appear at a particular location (e.g., a location corresponding to a physical landmark) within the physical area 112. The visual representation 140 is presented with a particular orientation relative to the particular physical landmark corresponding to the location, and the orientation 116 of the user. For example, in FIG. 1D, the visual representation 140 of the other user 121 is oriented such that the visual representation 140 appears to be facing the physical object 134-2 (e.g., a computer monitor), which may be based on interaction that the other user 121 is engaged in within the remote physical area 114. The visual representation may be presented with the particular orientation shown in FIG. 1D based on an interaction that the user 121 is performing within the remote physical area 114 (e.g., watching a program on a television display. In accordance with some embodiments, the physical object 134-2 is identified within the physical area 112 based on the physical object 134-2 satisfying similarity criteria in comparison with a physical object (or a virtual object) that the user 121 is interacting with in the remote physical area 114. In accordance with some embodiments, if a respective user is interacting with a physical object in their respective physical area, and there is no corresponding physical object within the other physical area where the representation of the respective user is being presented, one or more mitigation options may be used to determine how to convey the interaction within the other physical area. For example, a virtual object may be identified and/or generated to be used as a similar object for the respective physical object.

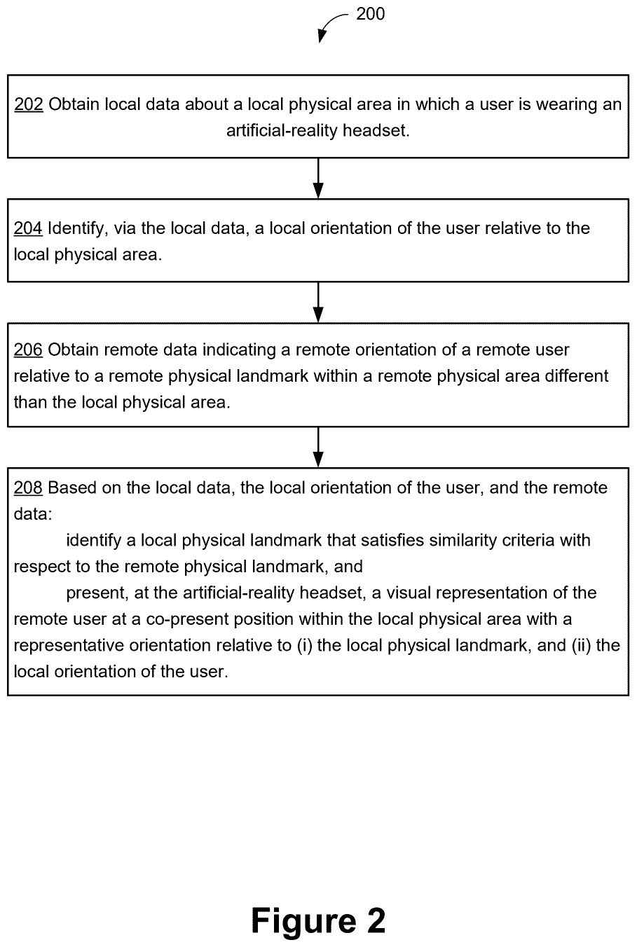

FIG. 2 illustrates a flow diagram of a method 200 of orienting a visual representation of a remote user based on physical landmarks within local physical surroundings of a user during a shared AR interaction, in accordance with some embodiments. Operations (e.g., steps) of the method 200 can be performed by one or more processors (e.g., central processing unit and/or MCU) (e.g., of the example AR system 300a). At least some of the operations shown in FIG. 2 correspond to instructions stored in a computer memory or computer-readable storage medium (e.g., storage, RAM, and/or memory). Operations of the method 200 can be performed by a single device alone or in conjunction with one or more processors and/or hardware components of another communicatively coupled device (e.g., the HIPD 600 operating in conjunction with the AR device 500 as part of the AR system 300a) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by one or more particular component(s) or device(s), but should not be construed as limiting the performance of the operation to the particular device in all embodiments.

(A1) The AR system 300a obtains (202) local data about a local physical area in which a user is wearing an AR headset (e.g., using one or more sensors on a front-facing outer cover of the AR headset (e.g., one or more of the front-facing imaging sensors 539A and 539B of the AR device 500 or the VR device 510)). For example, in FIG. 1A, the user 302 is wearing the AR device 500, and imaging sensors on a front surface and respective peripheral surfaces of the AR device 500 obtain imaging data of a physical area 112.

The AR system 300a identifies (204), via the local data, a local orientation of the user relative to the local physical area (e.g., the position and the direction of focus 116, of the user 302 shown in the mapping of the physical area 112 in FIG. 1A).

The AR system 300a obtains (206) remote data indicating a remote orientation of a remote user relative to a remote physical landmark within a remote physical area different than the local physical area (e.g., the orientation of the other user 121 relative to the physical object 126-2 (e.g., a couch that the other user 121 is sitting), and the pother physical object 126-1 (e.g., a television that the other user 121 is watching). In some embodiments, the remote data is received via the network connection 325 shown in FIG. 3A.

Based on the local data, the local orientation of the user, and the remote data, the AR system 300a identifies a local physical landmark that satisfies similarity criteria with respect to the remote physical landmark (e.g., the physical object 134-3 (e.g., a chair) shown in FIG. 1B of the physical area 112 is found to satisfy similarity criteria with respect to the physical object 126-2 (e.g., a couch) in the remote physical area 114), and the AR system 300a presents, at the AR headset, a visual representation of the remote user at a co-present position within the local physical area with a representative orientation relative to (i) the local physical landmark, and (ii) the local orientation of the user (208).

For example, a visual representation 140 (the avatar character shown in FIG. 1D) is presented within the physical area 112 with a representative orientation relative a local physical landmark (the physical object 134-2) based on the remote user's orientation relative to the physical object 126-1. And the visual representation 140 (e.g., an avatar character) is oriented to be facing the user 302 based on the orientation of the other user 121 in the remote physical area 114.

(A2) In some embodiments of A1, the local physical landmark is identified based on determining that the local physical landmark satisfies one or more similarity criteria. The one or more similarity criteria may be based on comparing semantic properties of the local physical landmark to other semantic properties of the remote physical landmark (e.g., intrinsic properties such as shape size, color, or material, and/or relational properties, such as function, purpose, or location of the respective physical objects). At least one of the one or more similarity criteria may be based on a physical relationship between the local physical landmark and one or more local real-world objects in the local physical area (e.g., the user or another real-world object in the user's physical area). At least one of the one or more similarity criteria may be based on a location of the remote user or the user in relation to a real-world boundary within the local physical area or the remote physical area (e.g., a physical boundary such as a wall, and/or an interaction boundary, such as an interfering object or the boundary of an interaction zone identified by the augmented-reality headset). That is, in some embodiments, the local and remote physical landmarks may be compared to determine a relative level of similarity between some physical aspects of the physical landmarks, which may be based on the particular interaction that a respective user is performing with respect to the physical landmarks. For example, if a user is staring at a television, similarity criteria may be based on whether a physical landmark in the other physical area includes a flat surface (e.g., a computer monitor, a painting on the wall).

(A3) In some embodiments of any one of A1 or A2, while the visual representation of the remote user is being presented at the co-present position with the representative orientation, the AR system 300a obtains additional remote data indicating that the remote user has adjusted a direction of focus within the remote physical area (e.g., a gaze direction, a particular stance that the remote user is in within the physical area). In some embodiments, based on the additional remote data, the AR system 300a determines whether a local physical object within the local physical area satisfies respective similarity criteria with respect to the remote physical landmark. In accordance with a determination that the local physical object satisfies the similarity criteria with respect to the remote physical landmark, the AR system 300a adjusts the representative orientation of the visual representation of the remote user with respect to the local physical object, such that the respective orientation corresponds to the adjusted direction of focus indicated by the additional remote data.

For example, in FIG. 1B, when the other user 121 turns to face the physical object 126-1 in the remote physical area 114, the visual representation 140 of the other user 121 is adjusted such that the visual representation is presented with a new orientation that is facing a computer monitor in the local physical area 112 (e.g., the physical object 134-2). In some embodiments, when the user 302 focuses their attention to a local physical landmark (e.g., a physical landmark, such as a real-world object or a position that one of the visual representations of a respective remote user is being presented, a visual representation of a remote user, etc.), the AR system 300a provides the local data about the adjusted focus to respective augmented-reality headsets of the remote users participating in the shared AR experience.

(A4) In some embodiments of A3, in accordance with another determination that no local physical objects satisfy the similarity criteria with respect to the remote physical landmark, the AR system 300a (i) instantiates another visual representation of the remote physical landmark within the local physical area, and (ii) adjusts the representative orientation of the visual representation of the remote user with respect to the other visual representation of the remote physical landmark to correspond to the adjusted direction of focus towards the remote physical landmark.

In other words, satisfaction of the similarity criteria may require an evaluation of the similarity criteria (e.g., a comparison against a similarity threshold), where a determination that no real-world object in the local physical area meets the similarity threshold with respect to the remote physical object causes the system to initiate a mitigation presentation strategy (e.g., fallback operations), where the mitigation presentation strategy does not require satisfaction of the similarity criteria. For example, in accordance with a determination that the remote user has adjusted their focus to a television in the remote physical area while there is no similar object (e.g., a different television, a computer monitor), a virtual object (e.g., shaped like a real-world television) may be instantiated by the user's AR headset within the local physical area.

(A5) In some embodiments of A4, an aspect of a visual appearance of the visual representation of the remote physical landmark is selected based on one or more other physical objects within the local physical area. For example, physical decor of the local physical area may be analyzed to determine an appropriate visual appearance element for the visual representation 140.

(A6) In some embodiments of any one of A1 to A5, based on the local orientation of the user within the local physical area (e.g., a three-dimensional volume of space within the local physical area that the user is capable of interacting with using the augmented reality headset), the AR system 300a identifies a target interaction region within the local physical area, where the co-present position is identified within the target interaction region. In some embodiments, the location of the three-dimensional interactable volume is based on a two-dimensional area of the ground in front of the user where there are not obstructive objects and/or area-bounding objects.

(A7) In some embodiments of A6, the AR system 300a presents, via the AR headset, a visual indication of the target interaction region (e.g., a visual representation of respective boundaries of the volume of space corresponding to the target interaction region). For example, a visual indication of the interactable distance configured for the AR system 300a may be presented to the user 302 while the user 302 is engaging the in the shared AR interaction with the other user 121.

(A8) In some embodiments of A1 to A7, determining the representative orientation of the visual representation of the remote user includes reflecting a gaze direction of the remote user relative to a remote physical object, such that the visual representation includes a different gaze direction with respect to the local physical landmark. For example, in accordance with a determination that the other user 121 is no longer oriented in a direction towards the physical object 126-1 in the remote physical area 114, the orientation of the visual representation 140 may be adjusted such that the visual representation 140 is no longer directed towards the physical object 134-2 in the physical area 112.

In some embodiments, other aspects of the visual representation can be reflected as part of orienting the visual representation of the remote user based on the interaction that the remote user is performing in relation to the remote physical landmark. For example, visual representations of arms, legs, and/or other body parts of the other user 121 may be adjusted as part of orienting the visual representation 140 of the other user 121 in FIG. 1D.

(A9) In some embodiments of A1 to A8, at a first time before the user is interacting with the remote user using the AR headset, while no AR content is being presented by the AR headset, the AR system 300a receives an indication that the remote user is attempting to interact with the user via the AR headset (e.g., initiating a video call). In some embodiments, in response to receiving the indication that the user has confirmed initiation of a shared interaction with the remote user via the AR headset, the AR system 300a obtains the local data.

(A10) In some embodiments of A1 to A9, responsive to a different remote user joining a shared AR experience (e.g., a virtual conference call) being performed by the user and the remote user, the AR system 300a (i) obtains other remote data identifying another remote position of the other remote user relative to another remote physical landmark, the other remote physical landmark positioned within another remote physical area in which the remote user is located, and (ii) presents within the local physical area, based on the local data and the other remote data, another visual representation of the other remote user. In some embodiments, the AR system 300a determines a physical landmark for positioning the different remote user based on a determined physical landmark where the other user 121 is being presented. For example, based on positioning the visual representation 140 near the physical object 134-3 in the physical area 112, a visual representation of the other remote user may be positioned in a virtual chair next to the physical object 134-3 to facilitate the co-presence of the AR interaction.

(A11) In some embodiments of A10, in conjunction with presenting the other visual representation of the other remote user within the local physical area based on the other remote data, the AR system 300a causes an adjustment to the visual representation of the remote user that includes an interaction with the other visual representation of the other remote user. For example, based on determining that the other user and the third user are having a conversation, show their respective visual representations turn towards each other within the local physical area 112.

(A12) In some embodiments of A1 to A11, based on at least the local data and the remote data obtained from the local physical area and the remote physical area, the AR system 300a generates a virtual scene, distinct from the local physical area and the remote physical area. In some embodiments, the virtual scene includes respective visual representations of the user and the remote user and at least one other visual representation corresponding to the local physical landmark and/or the remote physical landmark. In some embodiments, the co-present position of the visual representation of the remote user is determined, at least in part, based on a virtual co-present position of the remote user within the virtual scene. That is, the determination may be made based on a scene that does not correspond directly to any of the individual users' scenes.

In some embodiments, a virtual meeting (e.g., a shared AR interactive experience configured to host two or more users from different physical areas) is defined in a set of software operations as a script (e.g., a scene that would be fitting for the setting defined by one or more aspects of the shared AR experience). The AR system 300a simulates performance of a script defined by the scene fitting the shared AR experience, which may include co-present presentation criteria and/or similarity criteria of respective physical objects in one or more of the physical areas of a respective user of the shared AR experience. In some embodiments, a machine-learning model may be used to identify one or content components of the scene fitting the shared AR experience. For example, an artificial-intelligence component (e.g., a neural networks, such as a large language model) may generate descriptions of one or more scene components, including visual and non-visual aspects of the representative scene. In some embodiments, an AR scene director of the AR system 300a (which may include a large-language model) is configured to translate the script into proper choreography based on the location's constraint.

(A13) In some embodiments of A12, responsive to an input by the user to modify a presentation mode of the AR headset, such that the AR headset is caused to present a virtual-reality scene that encompasses substantially all of a particular field of view of the user, the AR system 300a presents, at the AR headset, the virtual scene that includes the respective visual representations of the user and the remote user (e.g., from the field of view of the respective virtual representation of the local user). In some embodiments, the virtual scene includes one or more background components based on the context of the AR interaction. For example, an AR interaction related to a work assignment may include an office background setting (e.g., including a conference room table having virtual seats for one or more remote users engaged in the AR interaction).

(A14) In some embodiments of A1 to A13, the representative orientation of the visual representation of the remote user is based on a respective remote object, different than the remote physical landmark, that the remote user is interacting with in the remote physical area, and the visual representation of the remote user is oriented to represent a remote-object orientation of the remote user with respect to the remote object. For example, the other user 121 may be interacting with a remote physical object, such as a television, mobile device, or a writing pad. Or the other user 121 may be interacting with a remote virtual object, such as a virtual screen or other virtual object. The method 200 may include representing the remote object (whether physical or virtual) within the local physical area 112 to facilitate a more realistic interaction between the user 302 and the other user 121.

(A15) In some embodiments of A14, the respective remote object is a physical object or a virtual object. And the method 200 further includes, in accordance with determining that the respective remote object is a physical object, based on determining that no object in the local physical area corresponds to the remote physical object, presenting a virtual object within the local physical area that corresponds to the remote physical object. For example, the other user 121 may be interacting with a mobile device (e.g., a tablet computing device), for which there is no physical object within the local physical area 112 that satisfies similarity criteria related to the remote physical object. In some embodiments, a determination whether a respective physical object in the local physical area 112 satisfies similarity criteria with respect to the remote physical object is based on whether the respective physical object in the local physical area has a sufficiently similar orientation with respect to the representation of the visual representation of the other user 121.

(A16) In some embodiments of A15, the method 200 further includes, in accordance with the determining that no respective physical or virtual objects within the local physical area satisfy the similarity criteria with respect to the remote physical object, determining which mitigation operation to perform based whether the remote physical object satisfies one or more co-present presentation criteria, including: (i) the remote physical object includes an identifiable interactive portion for use as part of a physical interaction by the remote user, (ii) the remote physical object is an interactive computing device having at least one user interface, and (iii) the remote physical object is being used as part of a shared AR interaction between the user and the remote user.

(A17) In some embodiments of A15 or A16, the method 200 further includes, in accordance with the determining that no respective physical or virtual objects within the local physical area satisfy the similarity criteria with respect to the remote physical object, and that the user will be prompted to cause presentation of the respective virtual object satisfying similarity criteria with respect to the remote physical object, presenting a plurality of different virtual object for selection by the user, wherein each respective virtual object of the plurality of different virtual objects satisfies similarity criteria with respect to the remote physical object.

(A18) In some embodiments of any one of A14 to A17, the method further includes, in accordance with determining that the respective remote object is a virtual object, in accordance with determining that no virtual objects currently being presented within the local physical area satisfy similarity criteria with respect to the remote virtual object, and that a respective local physical object satisfies similarity criteria with respect to the remote virtual object, orienting the visual representation of the remote user based on the respective local physical object.

As one example of the embodiments described by A14 to A18, consider that the other user 121 is looking at a physical plant within the remote physical area 114, while the other user 121 is interacting with the user 302 via the shared AR interaction. The AR system 300a may make one or more in a sequence of decisions to determine if and how to represent the interaction by the other user 121 with the physical plant in the remote physical area 114. For example, if there is a physical plant within the local physical area 112, then the visual representation of the remote user may be oriented based on the location of the local physical plant. If there is no physical plant within the local physical area 112, but there is virtual object that is currently being presented within the local physical area 112, then the visual representation of the other user 121 may be oriented based on the location of the similar virtual object. And if there is no physical or virtual object within the local physical area 112, then the AR system 300a may determine whether to prompt the user to cause a new virtual object to be presented, automatically present a similar virtual object, or forgo presenting an indication with the interaction, based on determining that the interaction with the remote physical plant is not necessary, or does not satisfy respective co-present presentation criteria, for being represented by the AR system 300a within the local physical area 112.

(B1) In accordance with some embodiments, a system that includes one or more wrist wearable devices and an AR headset, and the system is configured to perform operations corresponding to any of A1-A18.

(C1) In accordance with some embodiments, a non-transitory computer readable storage medium including instructions that, when executed by a computing device in communication with an AR headset (e.g., or an intermediary processing device in electronic communication with the augmented-reality headset), cause the computer device to perform operations corresponding to any of A1-A18.

(D1) In accordance with some embodiments, a method of operating an artificial reality headset, including operations that correspond to any of A1-A18.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 400, a head-wearable device, an HIPD 600, a smart textile-based garment [&&]00, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) AR applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems 3A 3C-2

FIGS. 3A, 3B, 3C-1, and 3C-2 illustrate example AR systems, in accordance with some embodiments. FIG. 3A shows a first AR system 300a and first example user interactions using a wrist-wearable device 400, a head-wearable device (e.g., AR device 500), and/or a handheld intermediary processing device (HIPD) 600. FIG. 3B shows a second AR system 300b and second example user interactions using a wrist-wearable device 400, AR device 500, and/or an HIPD 600. FIGS. 3C-1 and 3C-2 show a third AR system 300c and third example user interactions using a wrist-wearable device 400, a head-wearable device (e.g., virtual-reality (VR) device 510), and/or an HIPD 600.

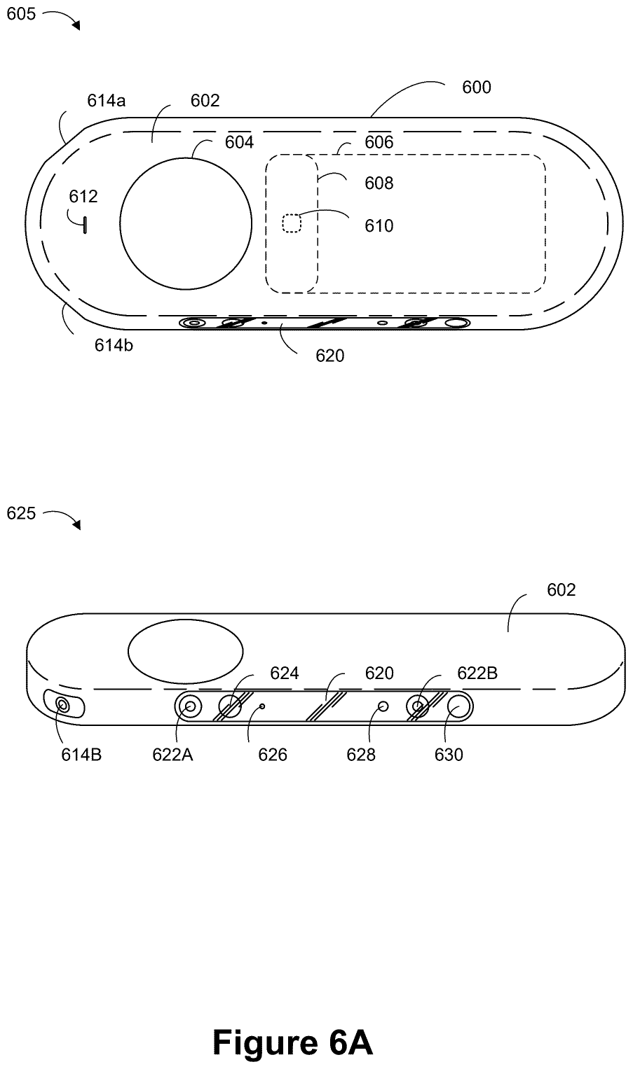

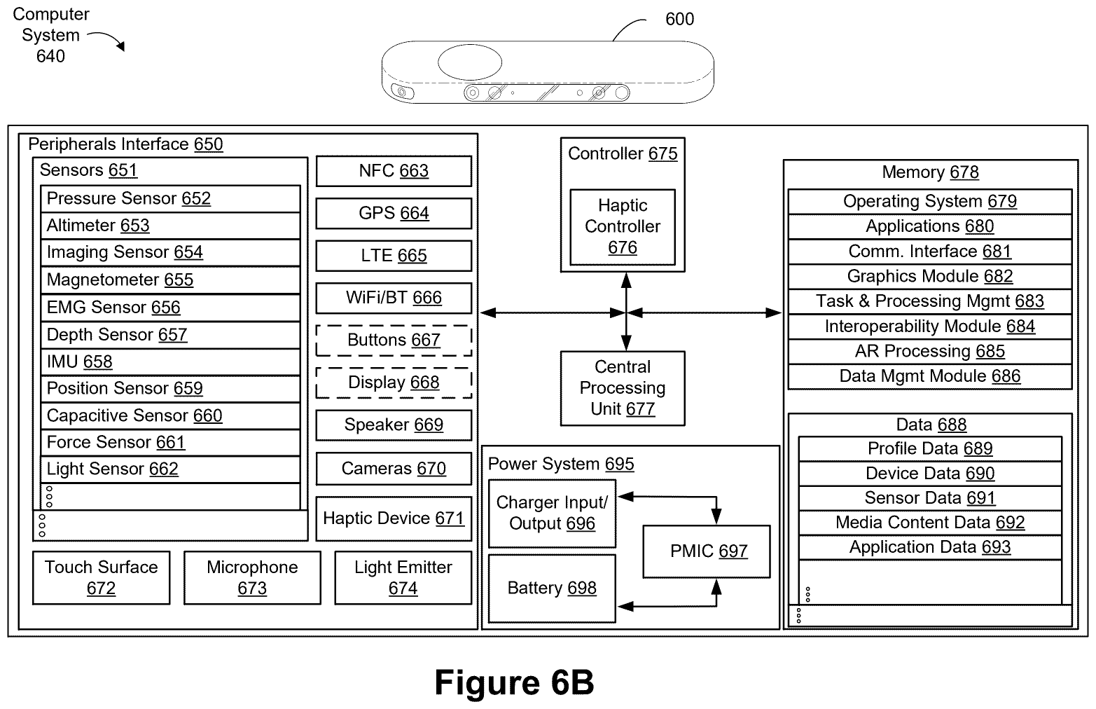

The wrist-wearable device 400 and its constituent components are described below in reference to FIGS. 4A-4B, the head-wearable devices and their constituent components are described below in reference to FIGS. 5A-5D, and the HIPD 600 and its constituent components are described below in reference to FIGS. 6A-6B. The wrist-wearable device 400, the head-wearable devices, and/or the HIPD 600 can communicatively couple via a network 325 (e.g., cellular, near field, Wi-Fi, personal area network, or wireless LAN). Additionally, the wrist-wearable device 400, the head-wearable devices, and/or the HIPD 600 can also communicatively couple with one or more servers 330, computers 340 (e.g., laptops or computers), mobile devices 350 (e.g., smartphones or tablets), and/or other electronic devices via the network 325 (e.g., cellular, near field, Wi-Fi, personal area network, or wireless LAN).

Turning to FIG. 3A, a user 302 is shown wearing the wrist-wearable device 400 and the AR device 500, and having the HIPD 600 on their desk. The wrist-wearable device 400, the AR device 500, and the HIPD 600 facilitate user interaction with an AR environment. In particular, as shown by the first AR system 300a, the wrist-wearable device 400, the AR device 500, and/or the HIPD 600 cause presentation of one or more avatars 304, digital representations of contacts 306, and virtual objects 308. As discussed below, the user 302 can interact with the one or more avatars 304, digital representations of the contacts 306, and virtual objects 308 via the wrist-wearable device 400, the AR device 500, and/or the HIPD 600.

The user 302 can use any of the wrist-wearable device 400, the AR device 500, and/or the HIPD 600 to provide user inputs. For example, the user 302 can perform one or more hand gestures that are detected by the wrist-wearable device 400 (e.g., using one or more EMG sensors and/or IMUs, described below in reference to FIGS. 4A-4B) and/or AR device 500 (e.g., using one or more image sensors or cameras, described below in reference to FIGS. 5A-5B) to provide a user input. Alternatively, or additionally, the user 302 can provide a user input via one or more touch surfaces of the wrist-wearable device 400, the AR device 500, and/or the HIPD 600, and/or voice commands captured by a microphone of the wrist-wearable device 400, the AR device 500, and/or the HIPD 600. In some embodiments, the wrist-wearable device 400, the AR device 500, and/or the HIPD 600 include a digital assistant to help the user in providing a user input (e.g., completing a sequence of operations, suggesting different operations or commands, providing reminders, or confirming a command). In some embodiments, the user 302 can provide a user input via one or more facial gestures and/or facial expressions. For example, cameras of the wrist-wearable device 400, the AR device 500, and/or the HIPD 600 can track the user 302's eyes for navigating a user interface.

The wrist-wearable device 400, the AR device 500, and/or the HIPD 600 can operate alone or in conjunction to allow the user 302 to interact with the AR environment. In some embodiments, the HIPD 600 is configured to operate as a central hub or control center for the wrist-wearable device 400, the AR device 500, and/or another communicatively coupled device. For example, the user 302 can provide an input to interact with the AR environment at any of the wrist-wearable device 400, the AR device 500, and/or the HIPD 600, and the HIPD 600 can identify one or more back-end and front-end tasks to cause the performance of the requested interaction and distribute instructions to cause the performance of the one or more back-end and front-end tasks at the wrist-wearable device 400, the AR device 500, and/or the HIPD 600. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). As described below in reference to FIGS. 6A-6B, the HIPD 600 can perform the back-end tasks and provide the wrist-wearable device 400 and/or the AR device 500 operational data corresponding to the performed back-end tasks such that the wrist-wearable device 400 and/or the AR device 500 can perform the front-end tasks. In this way, the HIPD 600, which has more computational resources and greater thermal headroom than the wrist-wearable device 400 and/or the AR device 500, performs computationally intensive tasks and reduces the computer resource utilization and/or power usage of the wrist-wearable device 400 and/or the AR device 500.

In the example shown by the first AR system 300a, the HIPD 600 identifies one or more back-end tasks and front-end tasks associated with a user request to initiate an AR video call with one or more other users (represented by the avatar 304 and the digital representation of the contact 306) and distributes instructions to cause the performance of the one or more back-end tasks and front-end tasks. In particular, the HIPD 600 performs back-end tasks for processing and/or rendering image data (and other data) associated with the AR video call and provides operational data associated with the performed back-end tasks to the AR device 500 such that the AR device 500 performs front-end tasks for presenting the AR video call (e.g., presenting the avatar 304 and the digital representation of the contact 306).

In some embodiments, the HIPD 600 can operate as a focal or anchor point for causing the presentation of information. This allows the user 302 to be generally aware of where information is presented. For example, as shown in the first AR system 300a, the avatar 304 and the digital representation of the contact 306 are presented above the HIPD 600. In particular, the HIPD 600 and the AR device 500 operate in conjunction to determine a location for presenting the avatar 304 and the digital representation of the contact 306. In some embodiments, information can be presented within a predetermined distance from the HIPD 600 (e.g., within five meters). For example, as shown in the first AR system 300a, virtual object 308 is presented on the desk some distance from the HIPD 600. Similar to the above example, the HIPD 600 and the AR device 500 can operate in conjunction to determine a location for presenting the virtual object 308. Alternatively, in some embodiments, presentation of information is not bound by the HIPD 600. More specifically, the avatar 304, the digital representation of the contact 306, and the virtual object 308 do not have to be presented within a predetermined distance of the HIPD 600.

User inputs provided at the wrist-wearable device 400, the AR device 500, and/or the HIPD 600 are coordinated such that the user can use any device to initiate, continue, and/or complete an operation. For example, the user 302 can provide a user input to the AR device 500 to cause the AR device 500 to present the virtual object 308 and, while the virtual object 308 is presented by the AR device 500, the user 302 can provide one or more hand gestures via the wrist-wearable device 400 to interact and/or manipulate the virtual object 308.

FIG. 3B shows the user 302 wearing the wrist-wearable device 400 and the AR device 500, and holding the HIPD 600. In the second AR system 300b, the wrist-wearable device 400, the AR device 500, and/or the HIPD 600 are used to receive and/or provide one or more messages to a contact of the user 302. In particular, the wrist-wearable device 400, the AR device 500, and/or the HIPD 600 detect and coordinate one or more user inputs to initiate a messaging application and prepare a response to a received message via the messaging application.

In some embodiments, the user 302 initiates, via a user input, an application on the wrist-wearable device 400, the AR device 500, and/or the HIPD 600 that causes the application to initiate on at least one device. For example, in the second AR system 300b, the user 302 performs a hand gesture associated with a command for initiating a messaging application (represented by messaging user interface 312), the wrist-wearable device 400 detects the hand gesture, and, based on a determination that the user 302 is wearing AR device 500, causes the AR device 500 to present a messaging user interface 312 of the messaging application. The AR device 500 can present the messaging user interface 312 to the user 302 via its display (e.g., as shown by user 302's field of view 310). In some embodiments, the application is initiated and can be run on the device (e.g., the wrist-wearable device 400, the AR device 500, and/or the HIPD 600) that detects the user input to initiate the application, and the device provides another device operational data to cause the presentation of the messaging application. For example, the wrist-wearable device 400 can detect the user input to initiate a messaging application, initiate and run the messaging application, and provide operational data to the AR device 500 and/or the HIPD 600 to cause presentation of the messaging application. Alternatively, the application can be initiated and run at a device other than the device that detected the user input. For example, the wrist-wearable device 400 can detect the hand gesture associated with initiating the messaging application and cause the HIPD 600 to run the messaging application and coordinate the presentation of the messaging application.

Further, the user 302 can provide a user input provided at the wrist-wearable device 400, the AR device 500, and/or the HIPD 600 to continue and/or complete an operation initiated at another device. For example, after initiating the messaging application via the wrist-wearable device 400 and while the AR device 500 presents the messaging user interface 312, the user 302 can provide an input at the HIPD 600 to prepare a response (e.g., shown by the swipe gesture performed on the HIPD 600). The user 302's gestures performed on the HIPD 600 can be provided and/or displayed on another device. For example, the user 302's swipe gestures performed on the HIPD 600 are displayed on a virtual keyboard of the messaging user interface 312 displayed by the AR device 500.

In some embodiments, the wrist-wearable device 400, the AR device 500, the HIPD 600, and/or other communicatively coupled devices can present one or more notifications to the user 302. The notification can be an indication of a new message, an incoming call, an application update, a status update, etc. The user 302 can select the notification via the wrist-wearable device 400, the AR device 500, or the HIPD 600 and cause presentation of an application or operation associated with the notification on at least one device. For example, the user 302 can receive a notification that a message was received at the wrist-wearable device 400, the AR device 500, the HIPD 600, and/or other communicatively coupled device and provide a user input at the wrist-wearable device 400, the AR device 500, and/or the HIPD 600 to review the notification, and the device detecting the user input can cause an application associated with the notification to be initiated and/or presented at the wrist-wearable device 400, the AR device 500, and/or the HIPD 600.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 500 can present to the user 302 game application data and the HIPD 600 can use a controller to provide inputs to the game. Similarly, the user 302 can use the wrist-wearable device 400 to initiate a camera of the AR device 500, and the user can use the wrist-wearable device 400, the AR device 500, and/or the HIPD 600 to manipulate the image capture (e.g., zoom in or out or apply filters) and capture image data.

Turning to FIGS. 3C-1 and 3C-2, the user 302 is shown wearing the wrist-wearable device 400 and a VR device 510, and holding the HIPD 600. In the third AR system 300c, the wrist-wearable device 400, the VR device 510, and/or the HIPD 600 are used to interact within an AR environment, such as a VR game or other AR application. While the VR device 510 presents a representation of a VR game (e.g., first AR game environment 320) to the user 302, the wrist-wearable device 400, the VR device 510, and/or the HIPD 600 detect and coordinate one or more user inputs to allow the user 302 to interact with the VR game.

In some embodiments, the user 302 can provide a user input via the wrist-wearable device 400, the VR device 510, and/or the HIPD 600 that causes an action in a corresponding AR environment. For example, the user 302 in the third AR system 300c (shown in FIG. 3C-1) raises the HIPD 600 to prepare for a swing in the first AR game environment 320. The VR device 510, responsive to the user 302 raising the HIPD 600, causes the AR representation of the user 322 to perform a similar action (e.g., raise a virtual object, such as a virtual sword 324). In some embodiments, each device uses respective sensor data and/or image data to detect the user input and provide an accurate representation of the user 302's motion. For example, imaging sensors 654 (e.g., SLAM cameras or other cameras discussed below in FIGS. 6A and 6B) of the HIPD 600 can be used to detect a position of the 600 relative to the user 302's body such that the virtual object can be positioned appropriately within the first AR game environment 320; sensor data from the wrist-wearable device 400 can be used to detect a velocity at which the user 302 raises the HIPD 600 such that the AR representation of the user 322 and the virtual sword 324 are synchronized with the user 302's movements; and image sensors 526 (FIGS. 5A-5C) of the VR device 510 can be used to represent the user 302's body, boundary conditions, or real-world objects within the first AR game environment 320.

In FIG. 3C-2, the user 302 performs a downward swing while holding the HIPD 600. The user 302's downward swing is detected by the wrist-wearable device 400, the VR device 510, and/or the HIPD 600 and a corresponding action is performed in the first AR game environment 320. In some embodiments, the data captured by each device is used to improve the user's experience within the AR environment. For example, sensor data of the wrist-wearable device 400 can be used to determine a speed and/or force at which the downward swing is performed and image sensors of the HIPD 600 and/or the VR device 510 can be used to determine a location of the swing and how it should be represented in the first AR game environment 320, which, in turn, can be used as inputs for the AR environment (e.g., game mechanics, which can use detected speed, force, locations, and/or aspects of the user 302's actions to classify a user's inputs (e.g., user performs a light strike, hard strike, critical strike, glancing strike, miss) or calculate an output (e.g., amount of damage)).

While the wrist-wearable device 400, the VR device 510, and/or the HIPD 600 are described as detecting user inputs, in some embodiments, user inputs are detected at a single device (with the single device being responsible for distributing signals to the other devices for performing the user input). For example, the HIPD 600 can operate an application for generating the first AR game environment 320 and provide the VR device 510 with corresponding data for causing the presentation of the first AR game environment 320, as well as detect the 302's movements (while holding the HIPD 600) to cause the performance of corresponding actions within the first AR game environment 320. Additionally or alternatively, in some embodiments, operational data (e.g., sensor data, image data, application data, device data, and/or other data) of one or more devices is provide to a single device (e.g., the HIPD 600) to process the operational data and cause respective devices to perform an action associated with processed operational data.

Having discussed example AR systems, devices for interacting with such AR systems, and other computing systems more generally, devices and components will now be discussed in greater detail below. Some definitions of devices and components that can be included in some or all of the example devices discussed below are defined here for case of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Wrist-Wearable Devices

FIGS. 4A and 4B illustrate an example wrist-wearable device 400, in accordance with some embodiments. FIG. 4A illustrates components of the wrist-wearable device 400, which can be used individually or in combination, including combinations that include other electronic devices and/or electronic components.

FIG. 4A shows a wearable band 410 and a watch body 420 (or capsule) being coupled, as discussed below, to form the wrist-wearable device 400. The wrist-wearable device 400 can perform various functions and/or operations associated with navigating through user interfaces and selectively opening applications, as well as the functions and/or operations described above with reference to FIGS. 1A to 1D.

As will be described in more detail below, operations executed by the wrist-wearable device 400 can include (i) presenting content to a user (e.g., displaying visual content via a display 405); (ii) detecting (e.g., sensing) user input (e.g., sensing a touch on peripheral button 423 and/or at a touch screen of the display 405, a hand gesture detected by sensors (e.g., biopotential sensors)); (iii) sensing biometric data via one or more sensors 413 (e.g., neuromuscular signals, heart rate, temperature, or sleep); messaging (e.g., text, speech, or video); image capture via one or more imaging devices or cameras 425; wireless communications (e.g., cellular, near field, Wi-Fi, or personal area network); location determination; financial transactions; providing haptic feedback; alarms; notifications; biometric authentication; health monitoring; and/or sleep monitoring.

The above-example functions can be executed independently in the watch body 420, independently in the wearable band 410, and/or via an electronic communication between the watch body 420 and the wearable band 410. In some embodiments, functions can be executed on the wrist-wearable device 400 while an AR environment is being presented (e.g., via one of the AR systems 300a to 300d). As the skilled artisan will appreciate upon reading the descriptions provided herein, the novel wearable devices described herein can be used with other types of AR environments.

The wearable band 410 can be configured to be worn by a user such that an inner (or inside) surface of the wearable structure 411 of the wearable band 410 is in contact with the user's skin. When worn by a user, sensors 413 contact the user's skin. The sensors 413 can sense biometric data such as a user's heart rate, saturated oxygen level, temperature, sweat level, neuromuscular-signal sensors, or a combination thereof. The sensors 413 can also sense data about a user's environment, including a user's motion, altitude, location, orientation, gait, acceleration, position, or a combination thereof. In some embodiments, the sensors 413 are configured to track a position and/or motion of the wearable band 410. The one or more sensors 413 can include any of the sensors defined above and/or discussed below with respect to FIG. 4B.

The one or more sensors 413 can be distributed on an inside and/or an outside surface of the wearable band 410. In some embodiments, the one or more sensors 413 are uniformly spaced along the wearable band 410. Alternatively, in some embodiments, the one or more sensors 413 are positioned at distinct points along the wearable band 410. As shown in FIG. 4A, the one or more sensors 413 can be the same or distinct. For example, in some embodiments, the one or more sensors 413 can be shaped as a pill (e.g., sensor 413a), an oval, a circle a square, an oblong (e.g., sensor 413c), and/or any other shape that maintains contact with the user's skin (e.g., such that neuromuscular signal and/or other biometric data can be accurately measured at the user's skin). In some embodiments, the one or more sensors 413 are aligned to form pairs of sensors (e.g., for sensing neuromuscular signals based on differential sensing within each respective sensor). For example, sensor 413b is aligned with an adjacent sensor to form sensor pair 414a, and sensor 413d is aligned with an adjacent sensor to form sensor pair 414b. In some embodiments, the wearable band 410 does not have a sensor pair. Alternatively, in some embodiments, the wearable band 410 has a predetermined number of sensor pairs (one pair of sensors, three pairs of sensors, four pairs of sensors, six pairs of sensors, or sixteen pairs of sensors).

The wearable band 410 can include any suitable number of sensors 413. In some embodiments, the amount, and arrangements of sensors 413 depend on the particular application for which the wearable band 410 is used. For instance, a wearable band 410 configured as an armband, wristband, or chest-band may include a plurality of sensors 413 with a different number of sensors 413 and different arrangement for each use case, such as medical use cases, compared to gaming or general day-to-day use cases.

In accordance with some embodiments, the wearable band 410 further includes an electrical ground electrode and a shielding electrode. The electrical ground and shielding electrodes, like the sensors 413, can be distributed on the inside surface of the wearable band 410 such that they contact a portion of the user's skin. For example, the electrical ground and shielding electrodes can be at an inside surface of coupling mechanism 416 or an inside surface of a wearable structure 411. The electrical ground and shielding electrodes can be formed and/or use the same components as the sensors 413. In some embodiments, the wearable band 410 includes more than one electrical ground electrode and more than one shielding electrode.

The sensors 413 can be formed as part of the wearable structure 411 of the wearable band 410. In some embodiments, the sensors 413 are flush or substantially flush with the wearable structure 411 such that they do not extend beyond the surface of the wearable structure 411. While flush with the wearable structure 411, the sensors 413 are still configured to contact the user's skin (e.g., via a skin-contacting surface). Alternatively, in some embodiments, the sensors 413 extend beyond the wearable structure 411 a predetermined distance (e.g., 0.1 mm to 2 mm) to make contact and depress into the user's skin. In some embodiments, the sensors 413 are coupled to an actuator (not shown) configured to adjust an extension height (e.g., a distance from the surface of the wearable structure 411) of the sensors 413 such that the sensors 413 make contact and depress into the user's skin. In some embodiments, the actuators adjust the extension height between 0.01 mm to 1.2 mm. This allows the user to customize the positioning of the sensors 413 to improve the overall comfort of the wearable band 410 when worn while still allowing the sensors 413 to contact the user's skin. In some embodiments, the sensors 413 are indistinguishable from the wearable structure 411 when worn by the user.

The wearable structure 411 can be formed of an elastic material, elastomers, etc., configured to be stretched and fitted to be worn by the user. In some embodiments, the wearable structure 411 is a textile or woven fabric. As described above, the sensors 413 can be formed as part of a wearable structure 411. For example, the sensors 413 can be molded into the wearable structure 411 or be integrated into a woven fabric (e.g., the sensors 413 can be sewn into the fabric and mimic the pliability of fabric (e.g., the sensors 413 can be constructed from a series of woven strands of fabric)).

The wearable structure 411 can include flexible electronic connectors that interconnect the sensors 413, the electronic circuitry, and/or other electronic components (described below in reference to FIG. 4B) that are enclosed in the wearable band 410. In some embodiments, the flexible electronic connectors are configured to interconnect the sensors 413, the electronic circuitry, and/or other electronic components of the wearable band 410 with respective sensors and/or other electronic components of another electronic device (e.g., watch body 420). The flexible electronic connectors are configured to move with the wearable structure 411 such that the user adjustment to the wearable structure 411 (e.g., resizing, pulling, or folding) does not stress or strain the electrical coupling of components of the wearable band 410.

As described above, the wearable band 410 is configured to be worn by a user. In particular, the wearable band 410 can be shaped or otherwise manipulated to be worn by a user. For example, the wearable band 410 can be shaped to have a substantially circular shape such that it can be configured to be worn on the user's lower arm or wrist. Alternatively, the wearable band 410 can be shaped to be worn on another body part of the user, such as the user's upper arm (e.g., around a bicep), forearm, chest, legs, etc. The wearable band 410 can include a retaining mechanism 412 (e.g., a buckle or a hook and loop fastener) for securing the wearable band 410 to the user's wrist or other body part. While the wearable band 410 is worn by the user, the sensors 413 sense data (referred to as sensor data) from the user's skin. In particular, the sensors 413 of the wearable band 410 obtain (e.g., sense and record) neuromuscular signals.

The sensed data (e.g., sensed neuromuscular signals) can be used to detect and/or determine the user's intention to perform certain motor actions. In particular, the sensors 413 sense and record neuromuscular signals from the user as the user performs muscular activations (e.g., movements or gestures). The detected and/or determined motor action (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 405 of the wrist-wearable device 400 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 413 can be used to provide a user with an enhanced interaction with a physical object (e.g., devices communicatively coupled with the wearable band 410) and/or a virtual object in an AR application generated by an AR system (e.g., user interface objects presented on the display 405 or another computing device (e.g., a smartphone)).

In some embodiments, the wearable band 410 includes one or more haptic devices 446 (FIG. 4B; e.g., a vibratory haptic actuator) that are configured to provide haptic feedback (e.g., a cutaneous and/or kinesthetic sensation) to the user's skin. The sensors 413 and/or the haptic devices 446 can be configured to operate in conjunction with multiple applications including, without limitation, health monitoring, social media, games, and AR (e.g., the applications associated with AR).

The wearable band 410 can also include a coupling mechanism 416 (e.g., a cradle or a shape of the coupling mechanism can correspond to the shape of the watch body 420 of the wrist-wearable device 400) for detachably coupling a capsule (e.g., a computing unit) or watch body 420 (via a coupling surface of the watch body 420) to the wearable band 410. In particular, the coupling mechanism 416 can be configured to receive a coupling surface proximate to the bottom side of the watch body 420 (e.g., a side opposite to a front side of the watch body 420 where the display 405 is located), such that a user can push the watch body 420 downward into the coupling mechanism 416 to attach the watch body 420 to the coupling mechanism 416. In some embodiments, the coupling mechanism 416 can be configured to receive a top side of the watch body 420 (e.g., a side proximate to the front side of the watch body 420 where the display 405 is located) that is pushed upward into the cradle, as opposed to being pushed downward into the coupling mechanism 416. In some embodiments, the coupling mechanism 416 is an integrated component of the wearable band 410 such that the wearable band 410 and the coupling mechanism 416 are a single unitary structure. In some embodiments, the coupling mechanism 416 is a type of frame or shell that allows the watch body 420 coupling surface to be retained within or on the wearable band 410 coupling mechanism 416 (e.g., a cradle, a tracker band, a support base, or a clasp).

The coupling mechanism 416 can allow for the watch body 420 to be detachably coupled to the wearable band 410 through a friction fit, a magnetic coupling, a rotation-based connector, a shear-pin coupler, a retention spring, one or more magnets, a clip, a pin shaft, a hook-and-loop fastener, or a combination thereof. A user can perform any type of motion to couple the watch body 420 to the wearable band 410 and to decouple the watch body 420 from the wearable band 410. For example, a user can twist, slide, turn, push, pull, or rotate the watch body 420 relative to the wearable band 410, or a combination thereof, to attach the watch body 420 to the wearable band 410 and to detach the watch body 420 from the wearable band 410. Alternatively, as discussed below, in some embodiments, the watch body 420 can be decoupled from the wearable band 410 by actuation of the release mechanism 429.

The wearable band 410 can be coupled with a watch body 420 to increase the functionality of the wearable band 410 (e.g., converting the wearable band 410 into a wrist-wearable device 400, adding an additional computing unit and/or battery to increase computational resources and/or a battery life of the wearable band 410, or adding additional sensors to improve sensed data). As described above, the wearable band 410 (and the coupling mechanism 416) is configured to operate independently (e.g., execute functions independently) from watch body 420. For example, the coupling mechanism 416 can include one or more sensors 413 that contact a user's skin when the wearable band 410 is worn by the user and provide sensor data for determining control commands.

A user can detach the watch body 420 (or capsule) from the wearable band 410 in order to reduce the encumbrance of the wrist-wearable device 400 to the user. For embodiments in which the watch body 420 is removable, the watch body 420 can be referred to as a removable structure, such that in these embodiments the wrist-wearable device 400 includes a wearable portion (e.g., the wearable band 410) and a removable structure (the watch body 420).

Turning to the watch body 420, the watch body 420 can have a substantially rectangular or circular shape. The watch body 420 is configured to be worn by the user on their wrist or on another body part. More specifically, the watch body 420 is sized to be easily carried by the user, attached on a portion of the user's clothing, and/or coupled to the wearable band 410 (forming the wrist-wearable device 400). As described above, the watch body 420 can have a shape corresponding to the coupling mechanism 416 of the wearable band 410. In some embodiments, the watch body 420 includes a single release mechanism 429 or multiple release mechanisms (e.g., two release mechanisms 429 positioned on opposing sides of the watch body 420, such as spring-loaded buttons) for decoupling the watch body 420 and the wearable band 410. The release mechanism 429 can include, without limitation, a button, a knob, a plunger, a handle, a lever, a fastener, a clasp, a dial, a latch, or a combination thereof.

A user can actuate the release mechanism 429 by pushing, turning, lifting, depressing, shifting, or performing other actions on the release mechanism 429. Actuation of the release mechanism 429 can release (e.g., decouple) the watch body 420 from the coupling mechanism 416 of the wearable band 410, allowing the user to use the watch body 420 independently from wearable band 410 and vice versa. For example, decoupling the watch body 420 from the wearable band 410 can allow the user to capture images using rear-facing camera 425b. Although the coupling mechanism 416 is shown positioned at a corner of watch body 420, the release mechanism 429 can be positioned anywhere on watch body 420 that is convenient for the user to actuate. In addition, in some embodiments, the wearable band 410 can also include a respective release mechanism for decoupling the watch body 420 from the coupling mechanism 416. In some embodiments, the release mechanism 429 is optional and the watch body 420 can be decoupled from the coupling mechanism 416, as described above (e.g., via twisting or rotating).

The watch body 420 can include one or more peripheral buttons 423 and 427 for performing various operations at the watch body 420. For example, the peripheral buttons 423 and 427 can be used to turn on or wake (e.g., transition from a sleep state to an active state) the display 405, unlock the watch body 420, increase or decrease volume, increase, or decrease brightness, interact with one or more applications, interact with one or more user interfaces. Additionally, or alternatively, in some embodiments, the display 405 operates as a touch screen and allows the user to provide one or more inputs for interacting with the watch body 420.

In some embodiments, the watch body 420 includes one or more sensors 421. The sensors 421 of the watch body 420 can be the same or distinct from the sensors 413 of the wearable band 410. The sensors 421 of the watch body 420 can be distributed on an inside and/or an outside surface of the watch body 420. In some embodiments, the sensors 421 are configured to contact a user's skin when the watch body 420 is worn by the user. For example, the sensors 421 can be placed on the bottom side of the watch body 420 and the coupling mechanism 416 can be a cradle with an opening that allows the bottom side of the watch body 420 to directly contact the user's skin. Alternatively, in some embodiments, the watch body 420 does not include sensors that are configured to contact the user's skin (e.g., including sensors internal and/or external to the watch body 420 that are configured to sense data of the watch body 420 and the watch body 420's surrounding environment). In some embodiments, the sensors 413 are configured to track a position and/or motion of the watch body 420.

The watch body 420 and the wearable band 410 can share data using a wired communication method (e.g., a Universal Asynchronous Receiver/Transmitter (UART) or a USB transceiver) and/or a wireless communication method (e.g., near-field communication or Bluetooth). For example, the watch body 420 and the wearable band 410 can share data sensed by the sensors 413 and 421, as well as application- and device-specific information (e.g., active and/or available applications), output devices (e.g., display or speakers), and/or input devices (e.g., touch screens, microphones, or imaging sensors).

In some embodiments, the watch body 420 can include, without limitation, a front-facing camera 425a and/or a rear-facing camera 425b, sensors 421 (e.g., a biometric sensor, an IMU sensor, a heart rate sensor, a saturated oxygen sensor, a neuromuscular-signal sensor, an altimeter sensor, a temperature sensor, a bioimpedance sensor, a pedometer sensor, an optical sensor (e.g., FIG. 4B; imaging sensor 463), a touch sensor, a sweat sensor). In some embodiments, the watch body 420 can include one or more haptic devices 476 (FIG. 4B; a vibratory haptic actuator) that is configured to provide haptic feedback (e.g., a cutaneous and/or kinesthetic sensation) to the user. The sensors 421 and/or the haptic device 476 can also be configured to operate in conjunction with multiple applications, including, without limitation, health-monitoring applications, social media applications, game applications, and AR applications (e.g., the applications associated with AR).

As described above, the watch body 420 and the wearable band 410, when coupled, can form the wrist-wearable device 400. When coupled, the watch body 420 and wearable band 410 operate as a single device to execute functions (e.g., operations, detections, or communications) described herein. In some embodiments, each device is provided with particular instructions for performing the one or more operations of the wrist-wearable device 400. For example, in accordance with a determination that the watch body 420 does not include neuromuscular-signal sensors, the wearable band 410 can include alternative instructions for performing associated instructions (e.g., providing sensed neuromuscular-signal data to the watch body 420 via a different electronic device). Operations of the wrist-wearable device 400 can be performed by the watch body 420 alone or in conjunction with the wearable band 410 (e.g., via respective processors and/or hardware components) and vice versa. In some embodiments, operations of the wrist-wearable device 400, the watch body 420, and/or the wearable band 410 can be performed in conjunction with one or more processors and/or hardware components of another communicatively coupled device (e.g., FIGS. 6A-6B; the HIPD 600).

As described below with reference to the block diagram of FIG. 4B, the wearable band 410 and/or the watch body 420 can each include independent resources required to independently execute functions. For example, the wearable band 410 and/or the watch body 420 can each include a power source (e.g., a battery), a memory, data storage, a processor (e.g., a CPU), communications, a light source, and/or input/output devices.

FIG. 4B shows block diagrams of a computing system 430 corresponding to the wearable band 410 and a computing system 460 corresponding to the watch body 420, according to some embodiments. A computing system of the wrist-wearable device 400 includes a combination of components of the wearable band computing system 430 and the watch body computing system 460, in accordance with some embodiments.

The watch body 420 and/or the wearable band 410 can include one or more components shown in watch body computing system 460. In some embodiments, a single integrated circuit includes all or a substantial portion of the components of the watch body computing system 460 that are included in a single integrated circuit. Alternatively, in some embodiments, components of the watch body computing system 460 are included in a plurality of integrated circuits that are communicatively coupled. In some embodiments, the watch body computing system 460 is configured to couple (e.g., via a wired or wireless connection) with the wearable band computing system 430, which allows the computing systems to share components, distribute tasks, and/or perform other operations described herein (individually or as a single device).

The watch body computing system 460 can include one or more processors 479, a controller 477, a peripherals interface 461, a power system 495, and memory (e.g., a memory 480), each of which are defined above and described in more detail below.

The power system 495 can include a charger input 496, a power-management integrated circuit (PMIC) 497, and a battery 498, each of which are defined above. In some embodiments, a watch body 420 and a wearable band 410 can have respective charger inputs (e.g., charger inputs 496 and 457), respective batteries (e.g., batteries 498 and 459), and can share power with each other (e.g., the watch body 420 can power and/or charge the wearable band 410 and vice versa). Although watch body 420 and/or the wearable band 410 can include respective charger inputs, a single charger input can charge both devices when coupled. The watch body 420 and the wearable band 410 can receive a charge using a variety of techniques. In some embodiments, the watch body 420 and the wearable band 410 can use a wired charging assembly (e.g., power cords) to receive the charge. Alternatively, or in addition, the watch body 420 and/or the wearable band 410 can be configured for wireless charging. For example, a portable charging device can be designed to mate with a portion of watch body 420 and/or wearable band 410 and wirelessly deliver usable power to a battery of watch body 420 and/or wearable band 410. The watch body 420 and the wearable band 410 can have independent power systems (e.g., power system 495 and 456) to enable each to operate independently. The watch body 420 and wearable band 410 can also share power (e.g., one can charge the other) via respective PMICs (e.g., PMICs 497 and 458) that can share power over power and ground conductors and/or over wireless charging antennas.

In some embodiments, the peripherals interface 461 can include one or more sensors 421, many of which listed below are defined above. The sensors 421 can include one or more coupling sensors 462 for detecting when the watch body 420 is coupled with another electronic device (e.g., a wearable band 410). The sensors 421 can include imaging sensors 463 (one or more of the cameras 425 and/or separate imaging sensors 463 (e.g., thermal-imaging sensors)). In some embodiments, the sensors 421 include one or more SpO2 sensors 464. In some embodiments, the sensors 421 include one or more biopotential-signal sensors (e.g., EMG sensors 465, which may be disposed on a user-facing portion of the watch body 420 and/or the wearable band 410). In some embodiments, the sensors 421 include one or more capacitive sensors 466. In some embodiments, the sensors 421 include one or more heart rate sensors 467. In some embodiments, the sensors 421 include one or more IMUs 468. In some embodiments, one or more IMUs 468 can be configured to detect movement of a user's hand or other location that the watch body 420 is placed or held.

In some embodiments, the peripherals interface 461 includes an NFC component 469, a GPS component 470, a long-term evolution (LTE) component 471, and/or a Wi-Fi and/or Bluetooth communication component 472. In some embodiments, the peripherals interface 461 includes one or more buttons 473 (e.g., the peripheral buttons 423 and 427 in FIG. 4A), which, when selected by a user, cause operations to be performed at the watch body 420. In some embodiments, the peripherals interface 461 includes one or more indicators, such as a light-emitting diode (LED), to provide a user with visual indicators (e.g., message received, low battery, an active microphone, and/or a camera).

The watch body 420 can include at least one display 405 for displaying visual representations of information or data to the user, including user-interface elements and/or three-dimensional (3D) virtual objects. The display can also include a touch screen for inputting user inputs, such as touch gestures, swipe gestures, and the like. The watch body 420 can include at least one speaker 474 and at least one microphone 475 for providing audio signals to the user and receiving audio input from the user. The user can provide user inputs through the microphone 475 and can also receive audio output from the speaker 474 as part of a haptic event provided by the haptic controller 478. The watch body 420 can include at least one camera 425, including a front-facing camera 425a and a rear-facing camera 425b. The cameras 425 can include ultra-wide-angle cameras, wide-angle cameras, fish-eye cameras, spherical cameras, telephoto cameras, depth-sensing cameras, or other types of cameras.

The watch body computing system 460 can include one or more haptic controllers 478 and associated componentry (e.g., haptic devices 476) for providing haptic events at the watch body 420 (e.g., a vibrating sensation or audio output in response to an event at the watch body 420). The haptic controllers 478 can communicate with one or more haptic devices 476, such as electroacoustic devices, including a speaker of the one or more speakers 474 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 478 can provide haptic events to respective haptic actuators that are capable of being sensed by a user of the watch body 420. In some embodiments, the one or more haptic controllers 478 can receive input signals from an application of the applications 482.

In some embodiments, the computer system 430 and/or the computer system 460 can include memory 480, which can be controlled by a memory controller of the one or more controllers 477 and/or one or more processors 479. In some embodiments, software components stored in the memory 480 include one or more applications 482 configured to perform operations at the watch body 420. In some embodiments, the one or more applications 482 include games, word processors, messaging applications, calling applications, web browsers, social media applications, media streaming applications, financial applications, calendars, clocks, etc. In some embodiments, software components stored in the memory 480 include one or more communication interface modules 483 as defined above. In some embodiments, software components stored in the memory 480 include one or more graphics modules 484 for rendering, encoding, and/or decoding audio and/or visual data; and one or more data management modules 485 for collecting, organizing, and/or providing access to the data 487 stored in memory 480. In some embodiments, one or more of applications 482 and/or one or more modules can work in conjunction with one another to perform various tasks at the watch body 420.

In some embodiments, software components stored in the memory 480 can include one or more operating systems 481 (e.g., a Linux-based operating system, an Android operating system, etc.). The memory 480 can also include data 487. The data 487 can include profile data 488A, sensor data 489A, media content data 490, and/or application data 491.

It should be appreciated that the watch body computing system 460 is an example of a computing system within the watch body 420, and that the watch body 420 can have more or fewer components than shown in the watch body computing system 460, combine two or more components, and/or have a different configuration and/or arrangement of the components. The various components shown in watch body computing system 460 are implemented in hardware, software, firmware, or a combination thereof, including one or more signal processing and/or application-specific integrated circuits.

Turning to the wearable band computing system 430, one or more components that can be included in the wearable band 410 are shown. The wearable band computing system 430 can include more or fewer components than shown in the watch body computing system 460, combine two or more components, and/or have a different configuration and/or arrangement of some or all of the components. In some embodiments, all, or a substantial portion of the components of the wearable band computing system 430 are included in a single integrated circuit. Alternatively, in some embodiments, components of the wearable band computing system 430 are included in a plurality of integrated circuits that are communicatively coupled. As described above, in some embodiments, the wearable band computing system 430 is configured to couple (e.g., via a wired or wireless connection) with the watch body computing system 460, which allows the computing systems to share components, distribute tasks, and/or perform other operations described herein (individually or as a single device).

The wearable band computing system 430, similar to the watch body computing system 460, can include one or more processors 449, one or more controllers 447 (including one or more haptics controller 448), a peripherals interface 431 that can include one or more sensors 413 and other peripheral devices, power source (e.g., a power system 456), and memory (e.g., a memory 450) that includes an operating system (e.g., an operating system 451), data (e.g., data 454 including profile data 488B, sensor data 489B, etc.), and one or more modules (e.g., a communications interface module 452, a data management module 453, etc.).

The one or more sensors 413 can be analogous to sensors 421 of the computer system 460 in light of the definitions above. For example, sensors 413 can include one or more coupling sensors 432, one or more SpO2 sensors 434, one or more EMG sensors 435, one or more capacitive sensors 436, one or more heart rate sensors 437, and one or more IMU sensors 438.

The peripherals interface 431 can also include other components analogous to those included in the peripheral interface 461 of the computer system 460, including an NFC component 439, a GPS component 440, an LTE component 441, a Wi-Fi and/or Bluetooth communication component 442, and/or one or more haptic devices 476 as described above in reference to peripherals interface 461. In some embodiments, the peripherals interface 431 includes one or more buttons 443, a display 433, a speaker 444, a microphone 445, and a camera 455. In some embodiments, the peripherals interface 431 includes one or more indicators, such as an LED.

It should be appreciated that the wearable band computing system 430 is an example of a computing system within the wearable band 410, and that the wearable band 410 can have more or fewer components than shown in the wearable band computing system 430, combine two or more components, and/or have a different configuration and/or arrangement of the components. The various components shown in wearable band computing system 430 can be implemented in one or a combination of hardware, software, and firmware, including one or more signal processing and/or application-specific integrated circuits.

The wrist-wearable device 400 with respect to FIG. 4A is an example of the wearable band 410 and the watch body 420 coupled, so the wrist-wearable device 400 will be understood to include the components shown and described for the wearable band computing system 430 and the watch body computing system 460. In some embodiments, wrist-wearable device 400 has a split architecture (e.g., a split mechanical architecture or a split electrical architecture) between the watch body 420 and the wearable band 410. In other words, all of the components shown in the wearable band computing system 430 and the watch body computing system 460 can be housed or otherwise disposed in a combined watch device 400, or within individual components of the watch body 420, wearable band 410, and/or portions thereof (e.g., a coupling mechanism 416 of the wearable band 410).

The techniques described above can be used with any device for sensing neuromuscular signals, including the arm-wearable devices of FIG. 4A-4B, but could also be used with other types of wearable devices for sensing neuromuscular signals (such as body-wearable or head-wearable devices that might have neuromuscular sensors closer to the brain or spinal column).

In some embodiments, a wrist-wearable device 400 can be used in conjunction with a head-wearable device described below (e.g., AR device 500 and VR device 510) and/or an HIPD 600, and the wrist-wearable device 400 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 500 and VR device 510.

### Example Head-Wearable Devices

FIGS. 5A, 5B-1, 5B-2, and 5C show example head-wearable devices, in accordance with some embodiments. Head-wearable devices can include, but are not limited to, AR devices 500 (e.g., AR or smart eyewear devices, such as smart glasses, smart monocles, smart contacts, etc.), VR devices 510 (e.g., VR headsets or head-mounted displays (HMDs)), or other ocularly coupled devices. The AR devices 500 and the VR devices 510 can perform various functions and/or operations associated with navigating through user interfaces and selectively opening applications, as well as the functions and/or operations described above with reference to FIGS. 1A to 1D.

In some embodiments, an AR system (e.g., FIGS. 3A to 3C-2; AR systems 300a-300d) includes an AR device 500 (as shown in FIG. 5A) and/or VR device 510 (as shown in FIGS. 5B-1-B-2). In some embodiments, the AR device 500 and the VR device 510 can include one or more analogous components (e.g., components for presenting interactive AR environments, such as processors, memory, and/or presentation devices, including one or more displays and/or one or more waveguides), some of which are described in more detail with respect to FIG. 5C. The head-wearable devices can use display projectors (e.g., display projector assemblies 507A and 507B) and/or waveguides for projecting representations of data to a user. Some embodiments of head-wearable devices do not include displays.

FIG. 5A shows an example visual depiction of the AR device 500 (e.g., which may also be described herein as augmented-reality glasses and/or smart glasses). The AR device 500 can work in conjunction with additional electronic components that are not shown in FIGS. 5A, such as a wearable accessory device and/or an intermediary processing device, in electronic communication or otherwise configured to be used in conjunction with the AR device 500. In some embodiments, the wearable accessory device and/or the intermediary processing device may be configured to couple with the AR device 500 via a coupling mechanism in electronic communication with a coupling sensor 524, where the coupling sensor 524 can detect when an electronic device becomes physically or electronically coupled with the AR device 500. In some embodiments, the AR device 500 can be configured to couple to a housing (e.g., a portion of frame 504 or temple arms 505), which may include one or more additional coupling mechanisms configured to couple with additional accessory devices. The components shown in FIG. 5A can be implemented in hardware, software, firmware, or a combination thereof, including one or more signal-processing components and/or application-specific integrated circuits (ASICs).

The AR device 500 includes mechanical glasses components, including a frame 504 configured to hold one or more lenses (e.g., one or both lenses 506-1 and 506-2). One of ordinary skill in the art will appreciate that the AR device 500 can include additional mechanical components, such as hinges configured to allow portions of the frame 504 of the AR device 500 to be folded and unfolded, a bridge configured to span the gap between the lenses 506-1 and 506-2 and rest on the user's nose, nose pads configured to rest on the bridge of the nose and provide support for the AR device 500, earpieces configured to rest on the user's ears and provide additional support for the AR device 500, temple arms 505 configured to extend from the hinges to the earpieces of the AR device 500, and the like. One of ordinary skill in the art will further appreciate that some examples of the AR device 500 can include none of the mechanical components described herein. For example, smart contact lenses configured to present AR to users may not include any components of the AR device 500.

The lenses 506-1 and 506-2 can be individual displays or display devices (e.g., a waveguide for projected representations). The lenses 506-1 and 506-2 may act together or independently to present an image or series of images to a user. In some embodiments, the lenses 506-1 and 506-2 can operate in conjunction with one or more display projector assemblies 507A and 507B to present image data to a user. While the AR device 500 includes two displays, embodiments of this disclosure may be implemented in AR devices with a single near-eye display (NED) or more than two NEDs.

The AR device 500 includes electronic components, many of which will be described in more detail below with respect to FIG. 5C. Some example electronic components are illustrated in FIG. 5A, including sensors 523-1, 523-2, 523-3, 523-4, 523-5, and 523-6, which can be distributed along a substantial portion of the frame 504 of the AR device 500. The different types of sensors are described below in reference to FIG. 5C. The AR device 500 also includes a left camera 539A and a right camera 539B, which are located on different sides of the frame 504. And the eyewear device includes one or more processors 548A and 548B (e.g., an integral microprocessor, such as an ASIC) that is embedded into a portion of the frame 504.

FIGS. 5B-1 and 5B-2 show an example visual depiction of the VR device 510 (e.g., a head-mounted display (HMD) 512, also referred to herein as an AR headset, a head-wearable device, or a VR headset). The HMD 512 includes a front body 514 and a frame 516 (e.g., a strap or band) shaped to fit around a user's head. In some embodiments, the front body 514 and/or the frame 516 includes one or more electronic elements for facilitating presentation of and/or interactions with an AR and/or VR system (e.g., displays, processors (e.g., processor 548A-1), IMUs, tracking emitters or detectors, or sensors). In some embodiments, the HMD 512 includes output audio transducers (e.g., an audio transducer 518-1), as shown in FIG. 5B-2. In some embodiments, one or more components, such as the output audio transducer(s) 518 and the frame 516, can be configured to attach and detach (e.g., are detachably attachable) to the HMD 512 (e.g., a portion or all of the frame 516 and/or the output audio transducer 518), as shown in FIG. 5B-2. In some embodiments, coupling a detachable component to the HMD 512 causes the detachable component to come into electronic communication with the HMD 512. The VR device 510 includes electronic components, many of which will be described in more detail below with respect to FIG. 5C.

FIGS. 5B-1 and 5B-2 also show that the VR device 510 having one or more cameras, such as the left camera 539A and the right camera 539B, which can be analogous to the left and right cameras on the frame 504 of the AR device 500. In some embodiments, the VR device 510 includes one or more additional cameras (e.g., cameras 539C and 539D), which can be configured to augment image data obtained by the cameras 539A and 539B by providing more information. For example, the camera 539C can be used to supply color information that is not discerned by cameras 539A and 539B. In some embodiments, one or more of the cameras 539A to 539D can include an optional IR (infrared) cut filter configured to remove IR light from being received at the respective camera sensors.

The VR device 510 can include a housing 590 storing one or more components of the VR device 510 and/or additional components of the VR device 510. The housing 590 can be a modular electronic device configured to couple with the VR device 510 (or an AR device 500) and supplement and/or extend the capabilities of the VR device 510 (or an AR device 500). For example, the housing 590 can include additional sensors, cameras, power sources, and processors (e.g., processor 548A-2) to improve and/or increase the functionality of the VR device 510. Examples of the different components included in the housing 590 are described below in reference to FIG. 5C.

Alternatively, or in addition, in some embodiments, the head-wearable device, such as the VR device 510 and/or the AR device 500, includes, or is communicatively coupled to, another external device (e.g., a paired device), such as an HIPD 6 (discussed below in reference to FIGS. 6A-6B) and/or an optional neckband. The optional neckband can couple to the head-wearable device via one or more connectors (e.g., wired, or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device 600, an optional neckband, and/or a wearable accessory device) with the head-wearable devices (e.g., an AR device 500 and/or a VR device 510) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 600) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 600, can process information generated by one or more of its sensors and/or information provided by other communicatively coupled devices. For example, a head-wearable device can include an IMU, and the intermediary processing device (a neckband and/or an HIPD 600) can compute all inertial and spatial calculations from the IMUs located on the head-wearable device. Additional examples of processing performed by a communicatively coupled device, such as the HIPD 600, are provided below in reference to FIGS. 6A and 6B.

AR systems may include a variety of types of visual feedback mechanisms. For example, display devices in the AR devices 500 and/or the VR devices 510 may include one or more liquid-crystal displays (LCDs), light emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 500 and/or the VR device 510 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 500 and the VR device 510, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 500 and/or the VR device 510 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 400, an HIPD 600, smart textile-based garment [&&]00), and/or other devices described herein.

FIG. 5C illustrates a computing system 520 and an optional housing 590, each of which shows components that can be included in a head-wearable device (e.g., the AR device 500 and/or the VR device 510). In some embodiments, more or fewer components can be included in the optional housing 590 depending on practical restraints of the respective head-wearable device being described. Additionally, or alternatively, the optional housing 590 can include additional components to expand and/or augment the functionality of a head-wearable device.

In some embodiments, the computing system 520 and/or the optional housing 590 can include one or more peripheral interfaces 522A and 522B, one or more power systems 542A and 542B (including charger input 543, PMIC 544, and battery 545), one or more controllers 546A and 546B (including one or more haptic controllers 547), one or more processors 548A and 548B (as defined above, including any of the examples provided), and memory 550A and 550B, which can all be in electronic communication with each other. For example, the one or more processors 548A and/or 548B can be configured to execute instructions stored in the memory 550A and/or 550B, which can cause a controller of the one or more controllers 546A and/or 546B to cause operations to be performed at one or more peripheral devices of the peripheral interfaces 522A and/or 522B. In some embodiments, each operation described can occur based on electrical power provided by the power system 542A and/or 542B.

In some embodiments, the peripherals interface 522A can include one or more devices configured to be part of the computing system 520, many of which have been defined above and/or described with respect to wrist-wearable devices shown in FIGS. 4A and 4B. For example, the peripherals interface can include one or more sensors 523A. Some example sensors include one or more coupling sensors 524, one or more acoustic sensors 525, one or more imaging sensors 526, one or more EMG sensors 527, one or more capacitive sensors 528, and/or one or more IMUs 529. In some embodiments, the sensors 523A further include depth sensors 567, light sensors 568, and/or any other types of sensors defined above or described with respect to any other embodiments discussed herein.

In some embodiments, the peripherals interface can include one or more additional peripheral devices, including one or more NFC devices 530, one or more GPS devices 531, one or more LTE devices 532, one or more Wi-Fi and/or Bluetooth devices 533, one or more buttons 534 (e.g., including buttons that are slidable or otherwise adjustable), one or more displays 535A, one or more speakers 536A, one or more microphones 537A, one or more cameras 538A (e.g., including the first camera 539-1 through nth camera 539-n, which are analogous to the left camera 539A and/or the right camera 539B), one or more haptic devices 540, and/or any other types of peripheral devices defined above or described with respect to any other embodiments discussed herein.

The head-wearable devices can include a variety of types of visual feedback mechanisms (e.g., presentation devices). For example, display devices in the AR device 500 and/or the VR device 510 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 535A can be coupled to each of the lenses 506-1 and 506-2 of the AR device 500. The displays 535A coupled to each of the lenses 506-1 and 506-2 can act together or independently to present an image or series of images to a user. In some embodiments, the AR device 500 and/or the VR device 510 includes a single display 535A (e.g., a near-eye display) or more than two displays 535A.

In some embodiments, a first set of one or more displays 535A can be used to present an augmented-reality environment, and a second set of one or more display devices 535A can be used to present a VR environment. In some embodiments, one or more waveguides are used in conjunction with presenting AR content to the user of the AR device 500 and/or the VR device 510 (e.g., as a means of delivering light from a display projector assembly and/or one or more displays 535A to the user's eyes). In some embodiments, one or more waveguides are fully or partially integrated into the AR device 500 and/or the VR device 510. Additionally, or alternatively, to display screens, some AR systems include one or more projection systems. For example, display devices in the AR device 500 and/or the VR device 510 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. The head-wearable devices can also be configured with any other suitable type or form of image projection system. In some embodiments, one or more waveguides are provided, additionally or alternatively, to the one or more display(s) 535A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15%-50% of the ambient light and/or the real-world live view) can be passed through the user interface element, such that the user can distinguish at least a portion of the physical environment over which the user interface element is being displayed.

The head-wearable devices can include one or more external displays 535A for presenting information to users. For example, an external display 535A can be used to show a current battery level, network activity (e.g., connected, disconnected), current activity (e.g., playing a game, in a call, in a meeting, or watching a movie), and/or other relevant information. In some embodiments, the external displays 535A can be used to communicate with others. For example, a user of the head-wearable device can cause the external displays 535A to present a “do not disturb” notification. The external displays 535A can also be used by the user to share any information captured by the one or more components of the peripherals interface 522A and/or generated by the head-wearable device (e.g., during operation and/or performance of one or more applications).

The memory 550A can include instructions and/or data executable by one or more processors 548A (and/or processors 548B of the housing 590) and/or a memory controller of the one or more controllers 546A (and/or controller 546B of the housing 590). The memory 550A can include one or more operating systems 551, one or more applications 552, one or more communication interface modules 553A, one or more graphics modules 554A, one or more AR processing modules 555A, and/or any other types of modules or components defined above or described with respect to any other embodiments discussed herein.

The data 560 stored in memory 550A can be used in conjunction with one or more of the applications and/or programs discussed above. The data 560 can include profile data 561, sensor data 562, media content data 563, AR application data 564; and/or any other types of data defined above or described with respect to any other embodiments discussed herein.

In some embodiments, the controller 546A of the head-wearable devices processes information generated by the sensors 523A on the head-wearable devices and/or another component of the head-wearable devices and/or communicatively coupled with the head-wearable devices (e.g., components of the housing 590, such as components of peripherals interface 522B). For example, the controller 546A can process information from the acoustic sensors 525 and/or image sensors 526. For each detected sound, the controller 546A can perform a direction of arrival (DOA) estimation to estimate a direction from which the detected sound arrived at a head-wearable device. As one or more of the acoustic sensors 525 detect sounds, the controller 546A can populate an audio data set with the information (e.g., represented by sensor data 562).

In some embodiments, a physical electronic connector can convey information between the head-wearable devices and another electronic device, and/or between one or more processors 548A of the head-wearable devices and the controller 546A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 600) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 500 and/or the VR device 510 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 5B-1 and 5B-2 show the VR device 510 having cameras 539A-539D, which can be used to provide depth information for creating a voxel field and a 2D mesh to provide object information to the user to avoid collisions.

The optional housing 590 can include analogous components to those describe above with respect to the computing system 520. For example, the optional housing 590 can include a respective peripherals interface 522B, including more or fewer components to those described above with respect to the peripherals interface 522A. As described above, the components of the optional housing 590 can be used to augment and/or expand on the functionality of the head-wearable devices. For example, the optional housing 590 can include respective sensors 523B, speakers 536B, displays 535B, microphones 537B, cameras 538B, and/or other components to capture and/or present data. Similarly, the optional housing 590 can include one or more processors 548B, controllers 546B, and/or memory 550B (including respective communication interface modules 553B, one or more graphics modules 554B, one or more AR processing modules 555B) that can be used individually and/or in conjunction with the components of the computing system 520.

The techniques described above in FIGS. 5A-5C can be used with different head-wearable devices. In some embodiments, the head-wearable devices (e.g., the AR device 500 and/or the VR device 510) can be used in conjunction with one or more wearable devices such as a wrist-wearable device 400 (or components thereof), as well as an HIPD 600. Having thus described example the head-wearable devices, attention will now be turned to example handheld intermediary processing devices, such as HIPD 600.

### Example Handheld Intermediary Processing Devices

FIGS. 6A and 6B illustrate an example handheld intermediary processing device (HIPD) 600, in accordance with some embodiments. The HIPD 600 can perform various functions and/or operations associated with navigating through user interfaces and selectively opening applications, as well as the functions and/or operations described above with reference to FIGS. 1A to 1D.

FIG. 6A shows a top view 605 and a side view 625 of the HIPD 600. The HIPD 600 is configured to communicatively couple with one or more wearable devices (or other electronic devices) associated with a user. For example, the HIPD 600 is configured to communicatively couple with a user's wrist-wearable device 400 (or components thereof, such as the watch body 420 and the wearable band 410), AR device 500, and/or VR device 510. The HIPD 600 can be configured to be held by a user (e.g., as a handheld controller), carried on the user's person (e.g., in their pocket or in their bag), placed in proximity of the user (e.g., placed on their desk while seated at their desk or on a charging dock), and/or placed at or within a predetermined distance from a wearable device or other electronic device (e.g., where, in some embodiments, the predetermined distance is the maximum distance (e.g., 10 meters) at which the HIPD 600 can successfully be communicatively coupled with an electronic device, such as a wearable device).

The HIPD 600 can perform various functions independently and/or in conjunction with one or more wearable devices (e.g., wrist-wearable device 400, AR device 500, and/or VR device 510). The HIPD 600 is configured to increase and/or improve the functionality of communicatively coupled devices, such as the wearable devices. The HIPD 600 is configured to perform one or more functions or operations associated with interacting with user interfaces and applications of communicatively coupled devices, interacting with an AR environment, interacting with a VR environment, and/or operating as a human-machine interface controller, as well as functions and/or operations described above with reference to FIGS. 1A to 1D. Additionally, as will be described in more detail below, functionality and/or operations of the HIPD 600 can include, without limitation, task offloading and/or handoffs, thermals offloading and/or handoffs, 6 degrees of freedom (6 DoF) raycasting and/or gaming (e.g., using imaging devices or cameras 614A and 614B, which can be used for simultaneous localization and mapping (SLAM), and/or with other image processing techniques), portable charging; messaging, image capturing via one or more imaging devices or cameras (e.g., cameras 622A and 622B), sensing user input (e.g., sensing a touch on a multitouch input surface 602), wireless communications and/or interlining (e.g., cellular, near field, Wi-Fi, or personal area network), location determination, financial transactions, providing haptic feedback, alarms, notifications, biometric authentication, health monitoring, sleep monitoring. The above-example functions can be executed independently in the HIPD 600 and/or in communication between the HIPD 600 and another wearable device described herein. In some embodiments, functions can be executed on the HIPD 600 in conjunction with an AR environment. As the skilled artisan will appreciate upon reading the descriptions provided herein, the novel HIPD 600 described herein can be used with any type of suitable AR environment.

While the HIPD 600 is communicatively coupled with a wearable device and/or other electronic device, the HIPD 600 is configured to perform one or more operations initiated at the wearable device and/or the other electronic device. In particular, one or more operations of the wearable device and/or the other electronic device can be offloaded to the HIPD 600 to be performed. The HIPD 600 performs one or more operations of the wearable device and/or the other electronic device and provides data corresponding to the completed operations to the wearable device and/or the other electronic device. For example, a user can initiate a video stream using the AR device 500 and back-end tasks associated with performing the video stream (e.g., video rendering) can be offloaded to the HIPD 600, which the HIPD 600 performs and provides corresponding data to the AR device 500 to perform remaining front-end tasks associated with the video stream (e.g., presenting the rendered video data via a display of the AR device 500). In this way, the HIPD 600, which has more computational resources and greater thermal headroom than a wearable device can perform computationally intensive tasks for the wearable device, improving performance of an operation performed by the wearable device.

The HIPD 600 includes a multi-touch input surface 602 on a first side (e.g., a front surface) that is configured to detect one or more user inputs. In particular, the multi-touch input surface 602 can detect single-tap inputs, multi-tap inputs, swipe gestures and/or inputs, force-based and/or pressure-based touch inputs, held taps, and the like. The multi-touch input surface 602 is configured to detect capacitive touch inputs and/or force (and/or pressure) touch inputs. The multi-touch input surface 602 includes a first touch-input surface 604 defined by a surface depression, and a second touch-input surface 606 defined by a substantially planar portion. The first touch-input surface 604 can be disposed adjacent to the second touch-input surface 606. In some embodiments, the first touch-input surface 604 and the second touch-input surface 606 can be different dimensions, shapes, and/or cover different portions of the multi-touch input surface 602. For example, the first touch-input surface 604 can be substantially circular and the second touch-input surface 606 is substantially rectangular. In some embodiments, the surface depression of the multi-touch input surface 602 is configured to guide user handling of the HIPD 600. In particular, the surface depression is configured such that the user holds the HIPD 600 upright when held in a single hand (e.g., such that the using imaging devices or cameras 614A and 614B are pointed toward a ceiling or the sky). Additionally, the surface depression is configured such that the user's thumb rests within the first touch-input surface 604.

In some embodiments, the different touch-input surfaces include a plurality of touch-input zones. For example, the second touch-input surface 606 includes at least a first touch-input zone 608 within a second touch-input zone 606 and a third touch-input zone 610 within the first touch-input zone 608. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 608 causes the HIPD 600 to perform a first command and a user input detected within the second touch-input zone 606 causes the HIPD 600 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 608 can be configured to detect force touch inputs (e.g., a magnitude at which the user presses down) and capacitive touch inputs, and the second touch-input zone 606 can be configured to detect capacitive touch inputs.

The HIPD 600 includes one or more sensors 651 for sensing data used in the performance of one or more operations and/or functions. For example, the HIPD 600 can include an IMU that is used in conjunction with cameras 614 for 3-dimensional object manipulation (e.g., enlarging, moving, destroying, etc. an object) in an AR or VR environment. Non-limiting examples of the sensors 651 included in the HIPD 600 include a light sensor, a magnetometer, a depth sensor, a pressure sensor, and a force sensor. Additional examples of the sensors 651 are provided below in reference to FIG. 6B.

The HIPD 600 can include one or more light indicators 612 to provide one or more notifications to the user. In some embodiments, the light indicators are LEDs or other types of illumination devices. The light indicators 612 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 604. The light indicators can be illuminated in different colors and/or patterns to provide the user with one or more notifications and/or information about the device. For example, a light indicator positioned around the first touch-input surface 604 can flash when the user receives a notification (e.g., a message), change red when the HIPD 600 is out of power, operate as a progress bar (e.g., a light ring that is closed when a task is completed (e.g., 0% to 100%)), operates as a volume indicator, etc.).

In some embodiments, the HIPD 600 includes one or more additional sensors on another surface. For example, as shown FIG. 6A, HIPD 600 includes a set of one or more sensors (e.g., sensor set 620) on an edge of the HIPD 600. The sensor set 620, when positioned on an edge of the of the HIPD 600, can be pe positioned at a predetermined tilt angle (e.g., 26 degrees), which allows the sensor set 620 to be angled toward the user when placed on a desk or other flat surface. Alternatively, in some embodiments, the sensor set 620 is positioned on a surface opposite the multi-touch input surface 602 (e.g., a back surface). The one or more sensors of the sensor set 620 are discussed in detail below.

The side view 625 of the of the HIPD 600 shows the sensor set 620 and camera 614B. The sensor set 620 includes one or more cameras 622A and 622B, a depth projector 624, an ambient light sensor 628, and a depth receiver 630. In some embodiments, the sensor set 620 includes a light indicator 626. The light indicator 626 can operate as a privacy indicator to let the user and/or those around them know that a camera and/or microphone is active. The sensor set 620 is configured to capture a user's facial expression such that the user can puppet a custom avatar (e.g., showing emotions, such as smiles, laughter, etc., on the avatar or a digital representation of the user). The sensor set 620 can be configured as a side stereo red-green-blue (RGB) system, a rear indirect time-of-flight (iToF) system, or a rear stereo RGB system. As the skilled artisan will appreciate upon reading the descriptions provided herein, the novel HIPD 600 described herein can use different sensor set 620 configurations and/or sensor set 620 placement.

In some embodiments, the HIPD 600 includes one or more haptic devices 671 (FIG. 6B; e.g., a vibratory haptic actuator) that are configured to provide haptic feedback (e.g., kinesthetic sensation). The sensors 651, and/or the haptic devices 671 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 600 is configured to operate without a display. However, in optional embodiments, the HIPD 600 can include a display 668 (FIG. 6B). The HIPD 600 can also income one or more optional peripheral buttons 667 (FIG. 6B). For example, the peripheral buttons 667 can be used to turn on or turn off the HIPD 600. Further, the HIPD 600 housing can be formed of polymers and/or elastomer elastomers. The HIPD 600 can be configured to have a non-slip surface to allow the HIPD 600 to be placed on a surface without requiring a user to watch over the HIPD 600. In other words, the HIPD 600 is designed such that it would not easily slide off a surfaces. In some embodiments, the HIPD 600 include one or magnets to couple the HIPD 600 to another surface. This allows the user to mount the HIPD 600 to different surfaces and provide the user with greater flexibility in use of the HIPD 600.

As described above, the HIPD 600 can distribute and/or provide instructions for performing the one or more tasks at the HIPD 600 and/or a communicatively coupled device. For example, the HIPD 600 can identify one or more back-end tasks to be performed by the HIPD 600 and one or more front-end tasks to be performed by a communicatively coupled device. While the HIPD 600 is configured to offload and/or handoff tasks of a communicatively coupled device, the HIPD 600 can perform both back-end and front-end tasks (e.g., via one or more processors, such as CPU 677; FIG. 6B). The HIPD 600 can, without limitation, can be used to perform augmenting calling (e.g., receiving and/or sending 3D or 2.5D live volumetric calls, live digital human representation calls, and/or avatar calls), discreet messaging, 6 DoF portrait/landscape gaming, AR/VR object manipulation, AR/VR content display (e.g., presenting content via a virtual display), and/or other AR/VR interactions. The HIPD 600 can perform the above operations alone or in conjunction with a wearable device (or other communicatively coupled electronic device).

FIG. 6B shows block diagrams of a computing system 640 of the HIPD 600, in accordance with some embodiments. The HIPD 600, described in detail above, can include one or more components shown in HIPD computing system 640. The HIPD 600 will be understood to include the components shown and described below for the HIPD computing system 640. In some embodiments, all, or a substantial portion of the components of the HIPD computing system 640 are included in a single integrated circuit. Alternatively, in some embodiments, components of the HIPD computing system 640 are included in a plurality of integrated circuits that are communicatively coupled.

The HIPD computing system 640 can include a processor (e.g., a CPU 677, a GPU, and/or a CPU with integrated graphics), a controller 675, a peripherals interface 650 that includes one or more sensors 651 and other peripheral devices, a power source (e.g., a power system 695), and memory (e.g., a memory 678) that includes an operating system (e.g., an operating system 679), data (e.g., data 688), one or more applications (e.g., applications 680), and one or more modules (e.g., a communications interface module 681, a graphics module 682, a task and processing management module 683, an interoperability module 684, an AR processing module 685, a data management module 686, etc.). The HIPD computing system 640 further includes a power system 695 that includes a charger input and output 696, a PMIC 697, and a battery 698, all of which are defined above.

In some embodiments, the peripherals interface 650 can include one or more sensors 651. The sensors 651 can include analogous sensors to those described above in reference to FIG. 4B. For example, the sensors 651 can include imaging sensors 654, (optional) EMG sensors 656, IMUs 658, and capacitive sensors 660. In some embodiments, the sensors 651 can include one or more pressure sensor 652 for sensing pressure data, an altimeter 653 for sensing an altitude of the HIPD 600, a magnetometer 655 for sensing a magnetic field, a depth sensor 657 (or a time-of flight sensor) for determining a difference between the camera and the subject of an image, a position sensor 659 (e.g., a flexible position sensor) for sensing a relative displacement or position change of a portion of the HIPD 600, a force sensor 661 for sensing a force applied to a portion of the HIPD 600, and a light sensor 662 (e.g., an ambient light sensor) for detecting an amount of lighting. The sensors 651 can include one or more sensors not shown in FIG. 6B.

Analogous to the peripherals described above in reference to FIGS. 4B, the peripherals interface 650 can also include an NFC component 663, a GPS component 664, an LTE component 665, a Wi-Fi and/or Bluetooth communication component 666, a speaker 669, a haptic device 671, and a microphone 673. As described above in reference to FIG. 6A, the HIPD 600 can optionally include a display 668 and/or one or more buttons 667. The peripherals interface 650 can further include one or more cameras 670, touch surfaces 672, and/or one or more light emitters 674. The multi-touch input surface 602 described above in reference to FIG. 6A is an example of touch surface 672. The light emitters 674 can be one or more LEDs, lasers, etc. and can be used to project or present information to a user. For example, the light emitters 674 can include light indicators 612 and 626 described above in reference to FIG. 6A. The cameras 670 (e.g., cameras 614A, 614B, and 622 described above in FIG. 6A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 670 can be used for SLAM; 6 DoF ray casting, gaming, object manipulation, and/or other rendering; facial recognition and facial expression recognition, etc.

Similar to the watch body computing system 460 and the watch band computing system 430 described above in reference to FIG. 4B, the HIPD computing system 640 can include one or more haptic controllers 676 and associated componentry (e.g., haptic devices 671) for providing haptic events at the HIPD 600.

Memory 678 can include high-speed random-access memory and/or non-volatile memory, such as one or more magnetic disk storage devices, flash memory devices, or other non-volatile solid-state memory devices. Access to the memory 678 by other components of the HIPD 600, such as the one or more processors and the peripherals interface 650, can be controlled by a memory controller of the controllers 675.

In some embodiments, software components stored in the memory 678 include one or more operating systems 679, one or more applications 680, one or more communication interface modules 681, one or more graphics modules 682, one or more data management modules 685, which are analogous to the software components described above in reference to FIG. 4B.

In some embodiments, software components stored in the memory 678 include a task and processing management module 683 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 683 uses data 688 (e.g., device data 690) to distribute the one or more front-end and/or back-end tasks based on communicatively coupled devices' computing resources, available power, thermal headroom, ongoing operations, and/or other factors. For example, the task and processing management module 683 can cause the performance of one or more back-end tasks (of an operation performed at communicatively coupled AR device 500) at the HIPD 600 in accordance with a determination that the operation is utilizing a predetermined amount (e.g., at least 70%) of computing resources available at the AR device 500.

In some embodiments, software components stored in the memory 678 include an interoperability module 684 for exchanging and utilizing information received and/or provided to distinct communicatively coupled devices. The interoperability module 684 allows for different systems, devices, and/or applications to connect and communicate in a coordinated way without user input. In some embodiments, software components stored in the memory 678 include an AR module 685 that is configured to process signals based at least on sensor data for use in an AR and/or VR environment. For example, the AR processing module 685 can be used for 3D object manipulation, gesture recognition, facial and facial expression, recognition, etc.

The memory 678 can also include data 687, including structured data. In some embodiments, the data 687 can include profile data 689, device data 689 (including device data of one or more devices communicatively coupled with the HIPD 600, such as device type, hardware, software, configurations, etc.), sensor data 691, media content data 692, and/or application data 693.

It should be appreciated that the HIPD computing system 640 is an example of a computing system within the HIPD 600, and that the HIPD 600 can have more or fewer components than shown in the HIPD computing system 640, combine two or more components, and/or have a different configuration and/or arrangement of the components. The various components shown in HIPD computing system 640 are implemented in hardware, software, firmware, or a combination thereof, including one or more signal processing and/or application-specific integrated circuits.

The techniques described above in FIG. 6A-6B can be used with any device used as a human-machine interface controller. In some embodiments, an HIPD 600 can be used in conjunction with one or more wearable device such as a head-wearable device (e.g., AR device 500 and VR device 510) and/or a wrist-wearable device 400 (or components thereof).

What is claimed is:

1. A non-transitory computer-readable storage medium, comprising instructions that, when executed by one or more processors, cause the processors to:
obtain local data about a local physical area in which a user is wearing an artificial-reality (AR) headset;
identify, via the local data, a local orientation of the user relative to the local physical area;
obtain remote data indicating a remote orientation of a remote user relative to a remote physical landmark within a remote physical area different than the local physical area; and
based on the local data, the local orientation of the user, and the remote data:
identify a local physical landmark that satisfies similarity criteria with respect to the remote physical landmark, and
present, at the AR headset, a visual representation of the remote user at a co-present position within the local physical area with a representative orientation relative to (i) the local physical landmark and (ii) the local orientation of the user.

2. The non-transitory computer-readable storage medium of claim 1, wherein:
the local physical landmark is identified based on determining that the local physical landmark satisfies one or more similarity criteria, the one or more similarity criteria based on one or more of:
comparing semantic properties of the local physical landmark to other semantic properties of the remote physical landmark;
a physical relationship between the local physical landmark and one or more local real-world objects in the local physical area; and/or
a location of the remote user or the user in relation to a real-world boundary within the local physical area or the remote physical area.

3. The non-transitory computer-readable storage medium of claim 1, further comprising instructions for causing the one or more processors to:
responsive to a different remote user joining a shared AR experience being performed by the user and the remote user:
obtain other remote data identifying another remote position of the different remote user relative to another remote physical landmark, positioned within another remote physical area in which the remote user is located; and
present within the local physical area, based on the local data and the other remote data, another visual representation of the different remote user.

4. The non-transitory computer-readable storage medium of claim 3, further comprising instructions for causing the one or more processors to:
in conjunction with presenting the other visual representation of the different remote user within the local physical area based on the other remote data:
cause an adjustment to the visual representation of the remote user that includes an interaction with the other visual representation of the different remote user.

5. The non-transitory computer-readable storage medium of claim 1, further comprising instructions for causing the one or more processors to:
based on at least the local data and the remote data obtained from the local physical area and the remote physical area:
generate a virtual scene, distinct from the local physical area and the remote physical area, wherein:
the virtual scene includes respective visual representations of the user and the remote user and at least one other visual representation corresponding to the local physical landmark and/or the remote physical landmark, and
the co-present position of the visual representation of the remote user is determined, at least in part, based on a virtual co-present position of the remote user within the virtual scene.

6. The non-transitory computer-readable storage medium of claim 5, further comprising instructions for causing the one or more processors to:
responsive to an input by the user to modify a presentation mode of the AR headset, such that the AR headset is caused to present a virtual-reality scene that encompasses substantially all of a particular field of view of the user:
present, at the AR headset, the virtual scene that includes the respective visual representations of the user and the remote user.

7. The non-transitory computer-readable storage medium of claim 1, wherein:
the representative orientation of the visual representation of the remote user is based on a respective remote object, different than the remote physical landmark, that the remote user is interacting with in the remote physical area; and
the visual representation of the remote user is oriented to represent a remote-object orientation of the remote user with respect to the remote object.

8. The non-transitory computer-readable storage medium of claim 7, wherein the respective remote object is a physical object or a virtual object, and the non-transitory computer-readable storage medium further comprises instructions for causing the one or more processors to:
based on determining that the respective remote object is a physical object:
in accordance with a first determination that a respective local physical object satisfies similarity criteria with the remote object, orient the visual representation of the remote user based on a respective location of the respective local physical object;
in accordance with a second determination that no respective local physical object satisfies similarity criteria with respect to the remote object, and that a respective virtual object within the local physical area satisfies similarity criteria with respect to the remote object, orient the visual representation of the remote user based on another respective location of the respective virtual object;
in accordance with a third determination that no respective physical or virtual objects within the local physical area satisfy similarity criteria with respect to the remote object, perform one or mitigation operations, including:
prompting the user to cause a new virtual object to be presented within the local physical area, the new virtual object satisfying similarity criteria with respect to the remote object;
presenting a new virtual object satisfying similarity criteria with respect to the remote object, and orienting the visual representation of the remote user based on the new virtual object; and/or
forgoing orienting the visual representation of the remote user based on the remote object.

9. The non-transitory computer-readable storage medium of claim 8, further comprising instructions for causing the one or more processors to:
in accordance with the determining that no respective physical or virtual objects within the local physical area satisfy the similarity criteria with respect to the remote object, determine a mitigation operation to perform based on whether the remote object satisfies one or more co-present presentation criteria comprising:
the remote object includes an identifiable interactive portion for use as part of a physical interaction by the remote user,
the remote object is an interactive computing device having at least one user interface, and
the remote physical object is being used as part of a shared AR interaction between the user and the remote user.

10. A system, comprising an augmented-reality headset, comprising one or more processors configured to:
obtain local data about a local physical area in which a user is wearing an artificial-reality (AR) headset;
identify, via the local data, a local orientation of the user relative to the local physical area;
obtain remote data indicating a remote orientation of a remote user relative to a remote physical landmark within a remote physical area different than the local physical area; and
based on the local data, the local orientation of the user, and the remote data:
identify a local physical landmark that satisfies similarity criteria with respect to the remote physical landmark, and
present, at the AR headset, a visual representation of the remote user at a co-present position within the local physical area with a representative orientation relative to (i) the local physical landmark and (ii) the local orientation of the user.

11. The system of claim 10, wherein:
the local physical landmark is identified based on determining that the local physical landmark satisfies one or more similarity criteria, the one or more similarity criteria based on one or more of:
comparing semantic properties of the local physical landmark to other semantic properties of the remote physical landmark;
a physical relationship between the local physical landmark and one or more local real-world objects in the local physical area; and/or
a location of the remote user or the user in relation to a real-world boundary within the local physical area or the remote physical area.

12. The system of claim 10, wherein the one or more processors are further configured to:
responsive to a different remote user joining a shared AR experience being performed by the user and the remote user:
obtain other remote data identifying another remote position of the different remote user relative to another remote physical landmark, positioned within another remote physical area in which the remote user is located; and
present within the local physical area, based on the local data and the other remote data, another visual representation of the different remote user.

13. The system of claim 12, wherein the one or more processors are further configured to:
in conjunction with presenting the other visual representation of the different remote user within the local physical area based on the other remote data:
cause an adjustment to the visual representation of the remote user that includes an interaction with the other visual representation of the different remote user.

14. The system of claim 10, wherein the one or more processors are further configured to:
based on at least the local data and the remote data obtained from the local physical area and the remote physical area:
generate a virtual scene, distinct from the local physical area and the remote physical area, wherein:
the virtual scene includes respective visual representations of the user and the remote user and at least one other visual representation corresponding to the local physical landmark and/or the remote physical landmark, and
the co-present position of the visual representation of the remote user is determined, at least in part, based on a virtual co-present position of the remote user within the virtual scene.

15. The system of claim 14, wherein the one or more processors are further configured to:
responsive to an input by the user to modify a presentation mode of the AR headset, such that the AR headset is caused to present a virtual-reality scene that encompasses substantially all of a particular field of view of the user:
present, at the AR headset, the virtual scene that includes the respective visual representations of the user and the remote user.

16. The system of claim 10, wherein:
the representative orientation of the visual representation of the remote user is based on a respective remote object, different than the remote physical landmark, that the remote user is interacting with in the remote physical area; and
the visual representation of the remote user is oriented to represent a remote-object orientation of the remote user with respect to the remote object.

17. The system of claim 16, wherein the respective remote object is a physical object or a virtual object, and the one or more processors are further configured to:
based on determining that the respective remote object is a physical object:
in accordance with a first determination that a respective local physical object satisfies similarity criteria with the remote object, orient the visual representation of the remote user based on a respective location of the respective local physical object;
in accordance with a second determination that no respective local physical object satisfies similarity criteria with respect to the remote object, and that a respective virtual object within the local physical area satisfies similarity criteria with respect to the remote object, orient the visual representation of the remote user based on another respective location of the respective virtual object;
in accordance with a third determination that no respective physical or virtual objects within the local physical area satisfy similarity criteria with respect to the remote object, perform one or mitigation operations, including:
prompting the user to cause a new virtual object to be presented within the local physical area, the new virtual object satisfying similarity criteria with respect to the remote object;
presenting a new virtual object satisfying similarity criteria with respect to the remote object, and orienting the visual representation of the remote user based on the new virtual object; and/or
forgoing orienting the visual representation of the remote user based on the remote object.

18. The system of claim 17, wherein the one or more processors are further configured to:
in accordance with the determining that no respective physical or virtual objects within the local physical area satisfy the similarity criteria with respect to the remote object, determine a mitigation operation to perform based on whether the remote object satisfies one or more co-present presentation criteria comprising:
the remote object includes an identifiable interactive portion for use as part of a physical interaction by the remote user,
the remote object is an interactive computing device having at least one user interface, and
the remote physical object is being used as part of a shared AR interaction between the user and the remote user.

19. A method, comprising:
obtain local data about a local physical area in which a user is wearing an artificial-reality (AR) headset;
identifying, via the local data, a local orientation of the user relative to the local physical area;
obtaining remote data indicating a remote orientation of a remote user relative to a remote physical landmark within a remote physical area different than the local physical area; and
based on the local data, the local orientation of the user, and the remote data:
identifying a local physical landmark that satisfies similarity criteria with respect to the remote physical landmark, and
presenting, at the AR headset, a visual representation of the remote user at a co-present position within the local physical area with a representative orientation relative to (i) the local physical landmark and (ii) the local orientation of the user.

20. The method of claim 19, wherein:
the local physical landmark is identified based on determining that the local physical landmark satisfies one or more similarity criteria, the one or more similarity criteria based on one or more of:
comparing semantic properties of the local physical landmark to other semantic properties of the remote physical landmark;
a physical relationship between the local physical landmark and one or more local real-world objects in the local physical area; and/or
a location of the remote user or the user in relation to a real-world boundary within the local physical area or the remote physical area.
